(19) United States
(12) Patent Application Publication
(10) Pub. No.: US 2018/0275067 A1
(43) Pub. Date: Sep. 27, 2018

(54) RAMAN SPECTROSCOPY

(71) Applicant: Sumitomo Chemical Company Limited, Tokyo (JP)

(72) Inventors: Matthew Roberts, Cambridge (GB); Irene Zaccari, Cambridgeshire (GB); May Wheeler, Cambridgeshire (GB)

(21) Appl. No.: 15/928,870

(22) Filed: Mar. 22, 2018

(30) Foreign Application Priority Data
Mar. 23, 2017 (GB) 1704588.1

(51) Int. Cl. G01N 21/65; B01L 3/00

(52) U.S. Cl. CPC G01N 21/658; B01L 2300/0681; B01L 3/5023; B01L 3/502

(57) ABSTRACT

A device for performing Raman spectroscopy is disclosed. The device comprises a sensor device comprising a transparent substrate having first and second opposite faces. The sensor device comprises a light source, a first grating, a first reflective element, and a light detector carried by the first face of the substrate. The light source is arranged to emit light towards the second face of the substrate and the light detector is directed at the second face of the substrate. The first grating is interposed between the light source and the light detector. The first reflective element is interposed between the light source and the first grating. The sensor device comprises a second grating and a second reflective element carried by the second face of the substrate, the second grating arranged to receive light from the light source and the second reflective element arranged to receive light from the first grating. The sensor device comprises a light-filtering layer disposed in the substrate between the first and second faces. The device for performing Raman spectroscopy comprises a fluidic device coupled to the sensor device next to the second face of the sensor device. The fluidic device comprises an analyte binding site next to the second face of the substrate, a port and a channel between the port and the analyte binding site for directing a test sample from the port to the analyte binding site. The light filtering layer comprises a first pair of light blocking regions arranged to provide a first aperture in a first optical path between the first grating and the detector and a second pair of light blocking regions arranged to provide a second aperture in a second optical path between the second grating and the analyte binding site.

### RELATED APPLICATIONS

This application claims foreign priority benefits under 35 U.S.C. § 119(a)-(d) or 35 U.S.C. § 365(b) of British application number 1704588.1, filed Mar. 23, 2017, the entirely of which is incorporated herein.

### FIELD Of THE INVENTION

The present invention relates to a device for performing Raman spectroscopy.

### BACKGROUND

Raman spectroscopy can be used to detect a target molecule, exploiting the characteristic Raman spectrum of a molecule.

Surface-enhanced Raman spectroscopy (SERS) can be performed to detect molecules in proximity to a metal surface or structure which can enhance the intensity of light scattered by the molecule and provide a higher-sensitivity measurement.

SERS has been used to detect biological substances, but the spectroscopy equipment required is commonly bulky, lab-based, and not portable.

US 2007/0153266 A1 describes a miniaturised spectroscopy system including a porous silicon device as a light source. The spectroscopy system uses an additional broadband light source to cause the porous silicon device to emit narrowband light.

### SUMMARY

According to a first aspect of the present invention, there is provided a device for performing Raman spectroscopy. The device comprises a sensor device and a fluidic device. The sensor device comprises a transparent substrate having first and second opposite faces and a light source, a first grating, a first reflective element, and a light detector carried by the first face of the substrate. The light source is arranged to emit light towards the second face of the substrate. The light detector is directed at the second face of the substrate. The first grating is interposed between the light source and the light detector. The first reflective element is interposed between the light source and the first grating. The sensor device comprises a second grating and a second reflective element carried by the second face of the substrate. The second grating is arranged to receive light from the light source. The second reflective element is arranged to receive light from the first gratin. The sensor device comprises a light-filtering layer disposed in the substrate between the first and second faces. The fluidic device is coupled to the sensor device next to the second face of the sensor device. The fluidic device comprises an analyte binding site next to the second face of the substrate.

The fluidic device comprises a port and a channel between the port and the analyte binding site for directing a test sample from the port to the analyte binding site. The light-filtering layer comprises a first pair of light blocking regions arranged to provide a first aperture in a first optical path between the first grating and the detector. The light-filtering layer comprises a second pair of light blocking regions arranged to provide a second aperture in a second optical path between the second grating and the analyte binding site.

This can provide a compact and cheap device for performing Raman spectroscopy.

The fluidic device may be removably coupled to the sensor device.

The fluidic device may comprise a field-enhancing particle disposed at or between the port and the analyte binding site, the field-enhancing particle suitable for binding to an analyte.

The fluidic device may comprise a reporter disposed at or between the port and the binding site.

The substrate may be flexible. The substrate may comprise a first substrate having first and second opposite faces and a second substrate having first and second opposite faces. The first substrate may be attached to the second substrate such that the second face of the first substrate is adjacent to the first face of the second substrate. The light-filtering layer may be disposed on the second face of the first substrate or on the first face of the second substrate. The first face of the substrate may be provided by the first face of the first substrate and the second face of the substrate may be provided by the second face of the second substrate.

The substrate may comprise a plastics material. The substrate may be a planar substrate.

The fluidic device may comprise a reference binding site next to the second face of the substrate, wherein the analyte binding site is between the port and the reference binding site.

The light source and the first grating may be spaced apart in a first direction and the fluidic device may comprise a reference binding site next to the second face of the substrate and spaced apart from the analyte binding site in the first direction. The light detector may comprise a first light detector and a second light detector spaced apart in the first direction and the light filtering layer may further comprise a third pair of light blocking regions arranged to provide a third aperture in a third optical path between the first grating and the second light detector and a fourth pair of light blocking regions arranged to provide a fourth aperture in a fourth optical path between the second grating and the reference binding site.

The first grating comprises a third grating and a fourth grating spaced apart in the first direction, the first optical path may be between the third grating portion and the first light detector, and the third optical path may be between the fourth grating and the second light detector. The third grating may be a third grating part or a third grating portion. The fourth grating may be a fourth grating part or a fourth grating portion.

The second grating may comprise a fifth grating and a sixth grating spaced apart in the first direction, the second optical path may be between the fifth grating and the analyte binding site, and the fourth optical path may be between the sixth grating and the reference binding site. The fifth grating may be a fifth grating part or a fifth grating portion. The sixth grating may be a sixth grating part or a sixth grating portion.

The first reflective element may comprise a third reflective element and a fourth reflective element spaced apart in the first direction. The third reflective element may be a third reflective element part or a third reflective element portion. The fourth reflective element may be a fourth reflective element part or a fourth reflective element portion.

The second reflective element may comprise a fifth reflective element and a sixth reflective element spaced apart in the first direction. The fifth reflective element may be a fifth reflective element part or a fifth reflective element portion. The sixth reflective element may be a sixth reflective element part or a sixth reflective element portion.

The light source may comprise a first light source and a second light source spaced apart in the first direction.

The light source and the first grating may be spaced apart in a first direction. The light detector may comprise a first light detector and a second light detector spaced apart in a second direction which is in the plane of the substrate and which is perpendicular to the first direction. The fluidic device may further comprise a reference binding site next to the second face of the substrate, the reference binding site being spaced apart from the analyte binding site in a direction parallel to the second direction.

The light source and the first grating may be spaced apart in a first direction. The light detector may comprise a first light detector and a second light detector spaced apart in a second direction which is in the plane of the substrate and which is perpendicular to the first direction. The analyte binding site may be a first analyte binding site and the fluidic device may further comprise a second analyte binding site next to the second face of the substrate, the second analyte binding site being spaced apart from the first analyte binding site in a direction parallel to the second direction.

The field-enhancing structure may comprise a nanoparticle. The nanoparticle may be a gold nanoparticle or a silver nanoparticle.

The or each analyte binding site may comprise a binding partner capable of specifically binding an analyte. The binding partner may be streptavidin.

The or each grating may comprise a conductive material. The or each grating may comprise a dielectric material. The or each grating may be etched into the substrate.

The light source may comprise a layer structure which includes a light-emitting layer.

The light-emitting layer may comprise a layer of organic material. The organic material may be a polymer.

The detector may comprise a layer of light-sensitive organic material.

The sensor device and the fluidic device are spaced apart by an index-matching layer.

The substrate may have a first refractive index and the index-matching layer may have a second refractive index which is substantially the same as the first reflective index.

The sensor device and the fluidic device may be spaced apart by an air gap.

The analyte may provide the reporter.

The reporter may be attached to the field-enhancing structure.

The fluidic device may be a lateral flow device. The lateral flow device may comprise a test strip forming the path for the test sample from the port to the binding site and the test strip may have a first end and a second, opposite end. The lateral flow device may comprise a wicking pad in fluid contact with the second end of the test strip. The port may be a conjugate pad in fluid contact with the first end of the test strip and the analyte binding site may be arranged between the first end of the test strip and the second end of the test strip.

The conjugate pad may comprise an analyte binding partner attached to the field-enhancing structure and the reporter molecule may be attached to the field-enhancing structure.

The conjugate pad may be a first conjugate pad and the lateral flow device may further comprise a second conjugate pad in fluid contact with the first conjugate pad. The second conjugate pad may comprise a first analyte binding partner attached to the field-enhancing structure and the reporter molecule may be attached to the field-enhancing structure. The first conjugate pad may comprise a second analyte binding partner attached to a biotin molecule. The first and the second analyte binding partners may be capable of binding a first analyte.

The reporter molecule may be a first reporter molecule. The second conjugate pad may comprise a third analyte binding partner and a second reporter molecule attached to a field-enhancing structure. The first conjugate pad may comprise a fourth analyte binding partner attached to a biotin molecule. The third and fourth analyte binding partners may be capable of binding a second analyte.

The analyte binding site may comprise streptavidin or avidin.

The lateral flow device may be supported by a transparent support sheet.

The fluidic device may be a flow cell or a well.

According to a second aspect of the present invention, there is provided a method comprising applying a sample to the port of a device according to the first aspect of the present invention.

According to a third aspect of the present invention there is provided a testing kit comprising a device according to the first aspect of the present invention.

According to a third aspect of the present invention there is provided apparatus comprising a device according to the first aspect of the present invention or a testing kit according to the third aspect of the present invention. The apparatus comprises a controller configured to apply a signal to the or each light source and to receive a signal from the or each detector.

### BRIEF DESCRIPTION OF THE DRAWINGS

Certain embodiments of the present invention will now be described, by way of example, with reference to the accompanying drawings, in which:

FIG. 1a is a cross-sectional view of a device for performing Raman spectroscopy including a sensor device and a fluidic device;

FIG. 1b illustrates flow of fluid through the fluidic device shown in FIG. 1a;

FIG. 1c illustrating light emission and detection in the device shown in FIG. 1a;

FIG. 2 illustrates in more detail the sensor device shown in FIG. 1a;

FIGS. 3a to 3d illustrate wavelength spectra of light at various stages of spectral and/or spatial filtering;

FIGS. 4a to 4c illustrate Raman and elastic scattering of light by a molecule;

FIG. 4d is a schematic diagram of a field-enhancing structure attached to a molecule;

FIG. 5 is a perspective view of a first lateral flow device;

FIGS. 6a to 6d illustrate fluid flow through the first lateral flow device shown in FIG. 5 included in a device for performing Raman spectroscopy;

FIGS. 7a and 7b are cross-sectional views of a second device for performing Raman spectroscopy;

FIG. 7c is a cross-sectional view of a first modified device for performing Raman spectroscopy;

FIG. 7d is a cross-sectional view of a second modified device for performing Raman spectroscopy;

FIGS. 8a to 8e are cross-sectional views of a third device for performing Raman spectroscopy illustrating fluid flow through a fluidic device comprised in the third device;

FIG. 9 is an exploded perspective view of a third sensing device which may be comprised in a device for performing Raman spectroscopy;

FIG. 10 is a plan view of a second light filtering layer;

FIG. 11 is a perspective view of a fourth device for performing Raman spectroscopy;

FIG. 12 is a perspective view of a fifth lateral flow device;

FIG. 13 is a plan view of a conjugate pad included in a fifth lateral flow device;

FIG. 14 is a plan view of a test layer included in a fifth lateral flow device;

FIG. 15 is an exploded perspective view of a fifth sensing device;

FIG. 16 is a perspective view of a fifth device for performing Raman spectroscopy including the fifth lateral flow device and the fifth sensing device;

FIG. 17 is a schematic block diagram of apparatus including a device for performing Raman spectroscopy and a control module;

FIG. 18 is a schematic block diagram of a control module;

FIG. 19 is a cross-sectional view of a first modified sensor device;

FIG. 20 is a cross-sectional view of a second modified sensor device;

FIG. 21 is an exploded cross-sectional view of a substrate included in a sensor device;

FIG. 22 is a perspective view of a fluidic device which is a well;

FIG. 23 is a cross-sectional view of a sixth device for performing Raman spectroscopy including a well;

FIG. 24 is a cross-sectional view of the sixth device where the well holds a liquid sample and a solution;

FIG. 25 is a perspective view of a fluidic device which includes a plurality of analyte and reference binding regions.

### DETAILED DESCRIPTION OF CERTAIN EMBODIMENTS

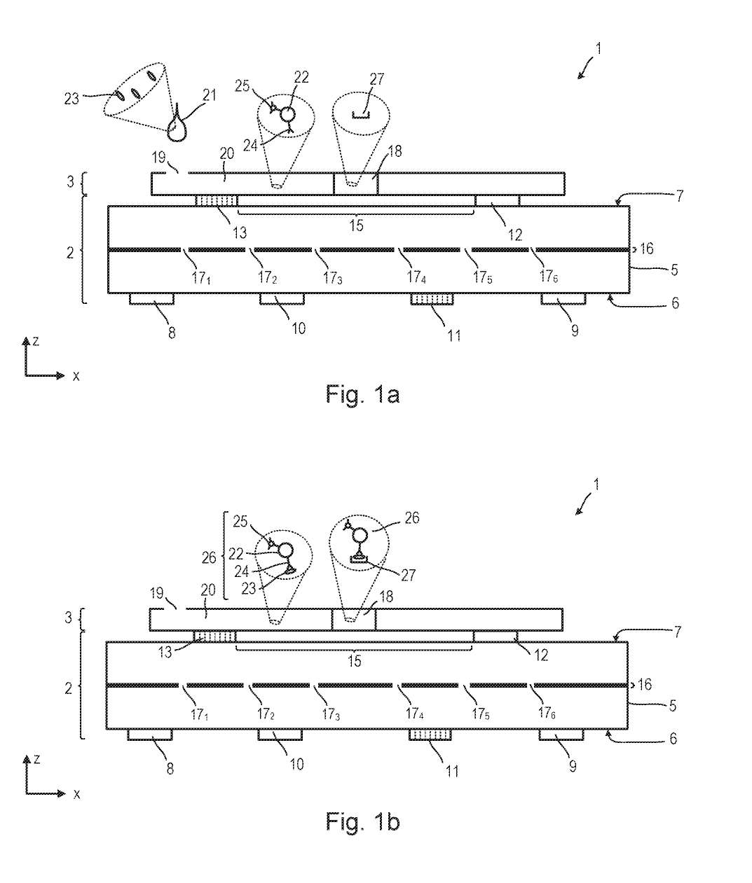

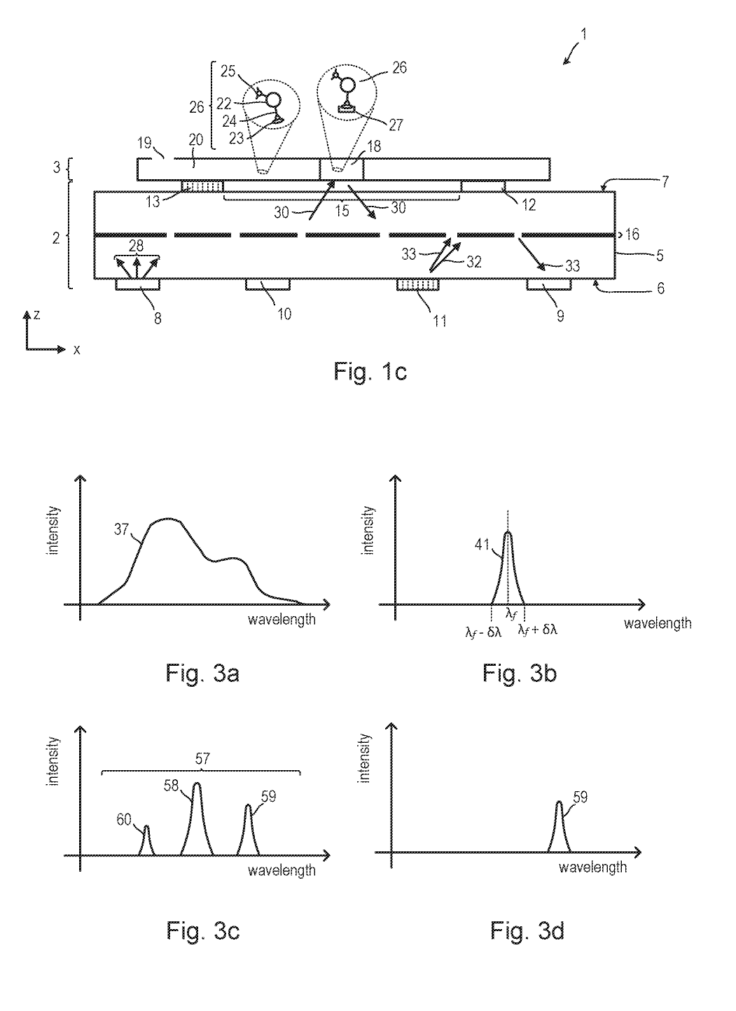

Referring to FIG. 1a, a device 1 for performing Raman spectroscopy is shown. The device 1 includes a sensor device 2 and a fluidic device 3 coupled to the sensor device 2.

The sensor device 2 includes a transparent substrate 5 having a first face 6 and a second, opposite face 7 (herein also referred to as the “lower face” and “upper face” respectively). As will be explained in more detail later, the substrate 5 may take the form of a laminate comprising at least two layers. The sensor device 2 includes a light source 8, a light detector 9, a first reflective element 10 and a first grating 11. The light source 8, light detector 9, first reflective element 10 and grating 11 are carried by, for example supported on, the first face 6 of the substrate 5. The sensor device 2 includes a second reflective element 12 and a second grating 13. The second reflective element 12 and the second grating 13 are carried by, for example supported on, the second face 6 of the substrate 5. The sensor device 2 includes a sensing region 15 next to the second face 7 of the substrate 5. The sensing region 15 is between the second reflective element 12 and the second grating 13.

The sensor device 2 includes a light-filtering layer 16 disposed in the substrate between the first face 6 and the second face 7. The light-filtering layer 16 includes first, second, third, fourth, fifth, and sixth apertures 17₁, 17₂, 17₃, 17₄, 17₅, 17₆.

The fluidic device 3 is arranged next to the second face 7 of the sensor device 4. The fluidic device 3 includes an analyte binding site 18 next to the sensing region 15 of the sensor device 2. The fluidic device 3 includes a port 19 and a channel 20 between the port 19 and the binding site 18 for passing a test sample 21 from the port 19 to the binding site 18. The fluidic device 3 includes a field-enhancing particle 22 disposed between the port 19 and the binding site 18. A first binding partner 24 capable of binding an analyte 23 is attached to the field-enhancing particle 22. The fluidic device 3 includes a reporter molecule 25 attached to the field-enhancing particle 22.

The test sample 4 may be a liquid, a solid or a gas, or a mixture, such as a suspension, gel or aerosol. The test sample 4 may be taken from a biological system, such as animal or plant, chemical system or other form of system such as an environmental system. The test sample 4 may be unprocessed, for example fresh whole blood or water sample taken from a river or reservoir, or processed, for example, filtered fresh whole blood or filtered water.

The fluidic device 3 is disposed next to the sensor device 2 such that the sensing region 15 of the sensor device 2 is next to the analyte binding site 18 of the fluidic device 3.

The fluidic device 3 may be coupled to the sensor device 2. The fluidic device may be removably coupled to the sensor device 2. The fluidic device 3 and the sensor device 2 may be coupled by means of an optically clear adhesive (not shown).

Referring to FIG. 1b, the test sample 21 is applied to the port 19 of the fluidic device 3. The test sample 21 may include at least one analyte 23 to be detected. The test sample 21 passes along the channel 20 and encounters the field-enhancing particle 22. If analyte 23 is present in the test sample 21, the analyte 23 may bind to the first binding partner 24 attached to the field-enhancing particle 22 to form a bound complex 26. The bound complex 26 passes along the channel 20 to the analyte binding site 18. The analyte binding site 18 includes a second binding partner 27 suitable for binding to the analyte 23. The bound complex 26 may be captured by the binding partner 27 and immobilised at the analyte binding site 18.

Referring to FIGS. 1b and 1c, the light source 8 is arranged to emit light 28 towards the second face 7 of the substrate 5. The first aperture 17₁ lies in a first light path 29₁ extending from the light source 8 towards the second grating 13. The second aperture 17₂ lies in a second light path 29₂ extending from the second grating 13 towards the first reflective element 10. The third aperture 17₃ lies in a third light path 29₃ extending from the first reflective element 10 towards the sensing region 15.

Emitted light 28 is spectrally filtered by the second grating 13 in combination with at least one of the first, second, and third apertures. Emitted light 28 may additionally be spatially filtered by the second grating 13 in combination with at least one of the first, second, and third apertures. Filtered excitation light 30 is incident at the binding site 18 of the fluidic device 3. The filtered excitation light 30 includes light at an excitation wavelength λ_{exc} suitable for exciting a Raman transition in a reporter molecule 25. The filtered excitation light 30 may excite a Raman transition in a reporter molecule 25 forming part of a bound complex 26 captured by a binding partner 27 and immobilised at the analyte binding site 18. The reporter molecule 25 emits light 31 following excitation.

Following excitation, the reporter molecule 25 may emit frequency-unshifted light 32 at the excitation wavelength λ_{exc}. Following excitation, the reporter molecule 25 may emit frequency-shifted light 33 at an emission wavelength λₑₘ which is different to the excitation wavelength λ_{exc}. The difference between the excitation wavelength and the emission wavelength may be indicative of the species of reporter molecule 25.

The fourth aperture 17₄ lies in a fourth light path 29₄ extending from the sensing region 15 towards the first grating 11. The fifth aperture 17₅ lies in a fifth light path 29₅ extending from the first grating 11 towards the second reflective element 12. The sixth aperture 17₆ lies in a sixth light path 29₆ extending from the second reflective element 12 towards the light detector 9.

Frequency-unshifted light 32 and frequency-shifted light 33 may be emitted towards the first grating 11. Frequency-unshifted light 32 and frequency-shifted light 33 is spectrally and/or spatially filtered by at least one of the first 11 grating and the first, second, and third apertures 17₄, 17₅, 17₆ such that the frequency-unshifted light 32 is blocked by the light filtering layer 16 and the frequency-shifted light is incident on the light detector 9.

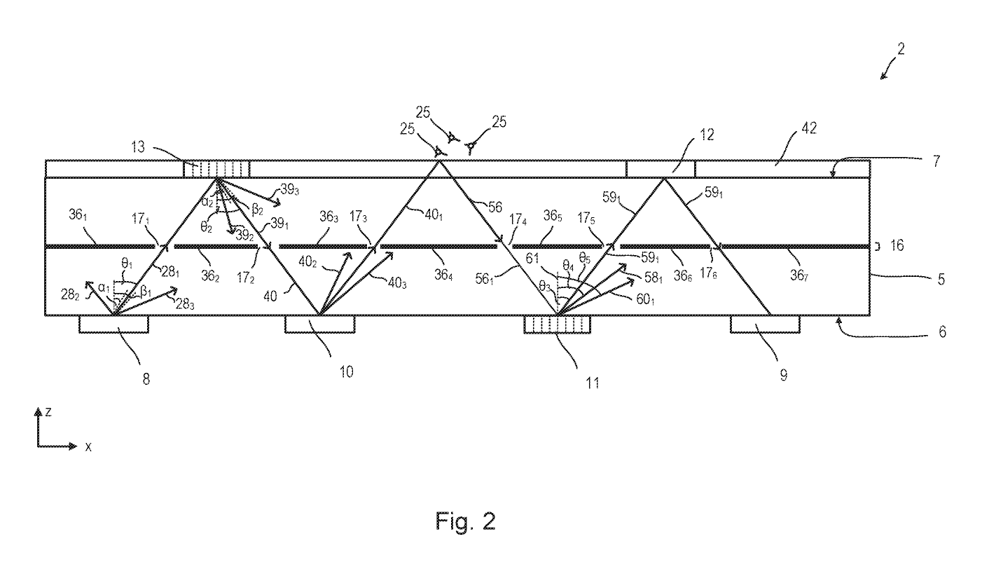

Referring to FIG. 2, the sensor device 2 is shown in more detail.

The transparent substrate 5 comprises a substantially optically transparent material, such as polyethylene terephthalate (PET), polyethylene naphthalate (PEN), poly(methyl methacrylate) (PMMA), a plastics material, or glass. The substrate 5 may be flexible, for example, capable of being reversibly bent through an angle of 90° or more. The substrate 5 has a thickness, t_{sub}, which may be, for example, less than 20 mm. The substrate 5 may be a planar substrate.

The light source 8 preferably comprises an organic light-emitting diode (OLED) or polymer light-emitting diode (PLED). At least a portion of the light source 8 is preferably fabricated using solution-processable materials. The light source 8 may comprise a light-emitting diode chip bonded to the first face 6 of the substrate 5.

The light source 8 emits source light 28 (FIG. 1c) towards the second face 7 of the substrate 5. The light source 8 is able to emit source light 28 generally centred on a normal 35 to the light source 8. Referring to FIG. 3a, the source light 28 has a broad spectrum 37.

The light-filtering layer 16 comprises a first light-blocking region 36₁ and a second light-blocking region 36₂ arranged to provide the first aperture 17₁. The first light-blocking region 36₁ and the second light-blocking region 36₂ are arranged such that source light emitted with an emission angle which is greater than a first lower limit angle α₁ and less than a first upper limit angle β₁ is passed by the first aperture 17₁.

The first portion 28₁ is emitted with an emission angle θ₁ measured in a clockwise sense from the normal 35 of the light source 8. The angle θ₁ is within a range of emission angles within which source light 28 is passed by the first aperture 17₁, that is, θ₁ is less than the first upper limit angle β₁ and greater than the first lower limit angle α₁.

The first light-blocking region 36₁ is arranged such that a second portion 28₂ of source light 28, which is emitted within a range of emission angles which are less than the first lower limit angle α₁, is blocked by the first light-blocking region 36₁. The second light-blocking region 36₂ is arranged such that a third portion 28₂ of source light 28, which is emitted within a range of emission angles which are greater than the first upper limit angle β₁, is blocked by the second light-blocking region 36₂.

The second grating element 13 is arranged so as to receive light from the light source 8 and to direct light towards the first face 6 of the substrate 5. The second grating element 13 includes a grating which is substantially reflective. For example, the second grating element 13 may be a ruled grating or a holographic grating. The second grating element 13 may be a deposited grating, for example a grating which is formed on the second face 6 of the substrate 4 by deposition of a reflective material. The reflective material may be deposited by, for example, chemical vapour deposition. The second grating element 13 may be an etched grating, that is, a grating which is etched into a reflective coating formed on the second face 6 of the substrate 4. The second grating element 13 may comprise a grating element bonded to the second face 6 of the substrate 4. For example, the second grating element 13 may comprise a holographic grating bonded to the second face 6 of the substrate.

The first portion 28₁ of source light 28 is incident on the second grating 13. The second grating 13 is a reflection grating having a grating normal 38. The second grating 13 angularly disperses light incident on it. That is, frequency components which were co-propagating before impinging on the second grating 13 will be spatially separated after diffraction by the second grating 13. After diffraction by the second grating 13, the first portion 28₁ of source light 28 comprises diffracted light 39.

The light-filtering layer 16 comprises a third light-blocking region 36₃. The second light-blocking region 36₂ and the third light-blocking region 36₃ are arranged to provide the second aperture 17₂. The second light-blocking region 36₂ and the third light-blocking region 36₃ are arranged such that diffracted light diffracted at an angle which is greater than a second lower limit angle α₂ and less than a second upper limit angle β₂ is passed by the second aperture 17₂.

A first portion 39₁ of diffracted light 39 is diffracted at a diffraction angle θ₂ measured in a clockwise sense from the normal 38 of the second grating 13. The diffraction angle θ₂ is within a range of emission angles within which diffracted light 39 is passed by the second aperture 17₂, that is, the diffraction angle θ₂ is less than the second upper limit angle β₂ and greater than the second lower limit angle α₂.

The second light-blocking region 36₂ is arranged such that a second portion 39₂ of diffracted light 39, which is diffracted within a range of emission angles which are less than the second lower limit angle α₂, is blocked by the second light-blocking region 36₂. The third light-blocking region 36₃ is arranged such that a third portion 39₂ of diffracted light 39, which is diffracted within a range of emission angles which are greater than the second upper limit angle β₂, is blocked by the third light-blocking region 36₃.

The portion 39₁ of diffracted light 39 which is passed by the second aperture 17₂ includes light having wavelengths within a first range λ_{f}±δλ. The light blocked by the second light-blocking region 36₂ includes light having wavelengths less than λ_{f}−δλ. The light blocked by the third light-blocking region 36₃ includes light having wavelengths greater than λ_{f}+δλ.

Filtered source light 40 comprises the first portion 39₁ of diffracted light 39 which is passed by the second aperture 17₂. Referring to FIG. 3b, the filtered source light 40 has a spectrum 41 which is narrower than the spectrum 37 of the source light 28 emitted by the light source 8. The position and dimensions of the light blocking regions 361, 362, 363, 364 are chosen such that the spectrum 41 of filtered source light 40 is centred on the excitation wavelength λ_{f} of a Raman mode of a reporter molecule 25.

The filtered source light 40 propagates towards the first reflective element 10. The first reflective element 10 is arranged so as to receive light from the second grating 13 and to direct light towards the second face 7 of the substrate 5. The first reflective element 10 may comprise a reflective material, for example, silver, aluminium, or titanium. The reflective material may be a conductive material. The reflective material may be a metal. The first reflective element 10 may be formed on the first face 6 of the substrate 5 by deposition of a reflective material. The reflective material may be deposited by, for example, a sputtering process or an evaporation process. The reflective material may be deposited by chemical vapour deposition. The first reflective element 10 may be a dielectric mirror. The first reflective element 10 may comprise a reflective element bonded to the first face 6 of the substrate 5.

The filtered source light 40 is reflected by the first reflective element 10 towards the second face 7 of the substrate 5.

The light-filtering layer 16 comprises a fourth light-blocking region 36₄. The third light-blocking region 36₃ and the fourth light-blocking region 36₄ are arranged to provide the third aperture 17₃. The third light-blocking region 36₃ and the fourth light-blocking region 36₄ are arranged such that at least a portion 40₁ of filtered source light 40 is passed by the third aperture 17₃. The third aperture 17₃ may provide further frequency selectivity of the filtered source light 40 by passing a first portion 40₁ of filtered source light 40 which has a narrower range of frequencies than filtered source light 40. Second and third portions 40₂, 40₃ of filtered source light 40 may be blocked by the third light-blocking region 36₃ and the fourth light-blocking region 36₄ respectively.

Excitation light 41 is incident at the second face 7 of the substrate 5. Excitation light 41 comprises the portion 40₁ of filtered source light 40 which is passed by the third aperture 17₃.

The sensor device 2 includes a capping layer 42 next to the second face 7 of the substrate 5. The capping layer 42 comprises a substantially optically transparent material, such as polyethylene terephthalate (PET), polyethylene naphthalate (PEN), or poly(methyl methacrylate) (PMMA). The capping layer 42 is index-matched to the substrate 5.

Excitation light 41 propagates through the capping layer 42. If a reporter molecule 25 is close to the capping layer 42, the excitation light 41 may excite a Raman transition in the reporter molecule 25.

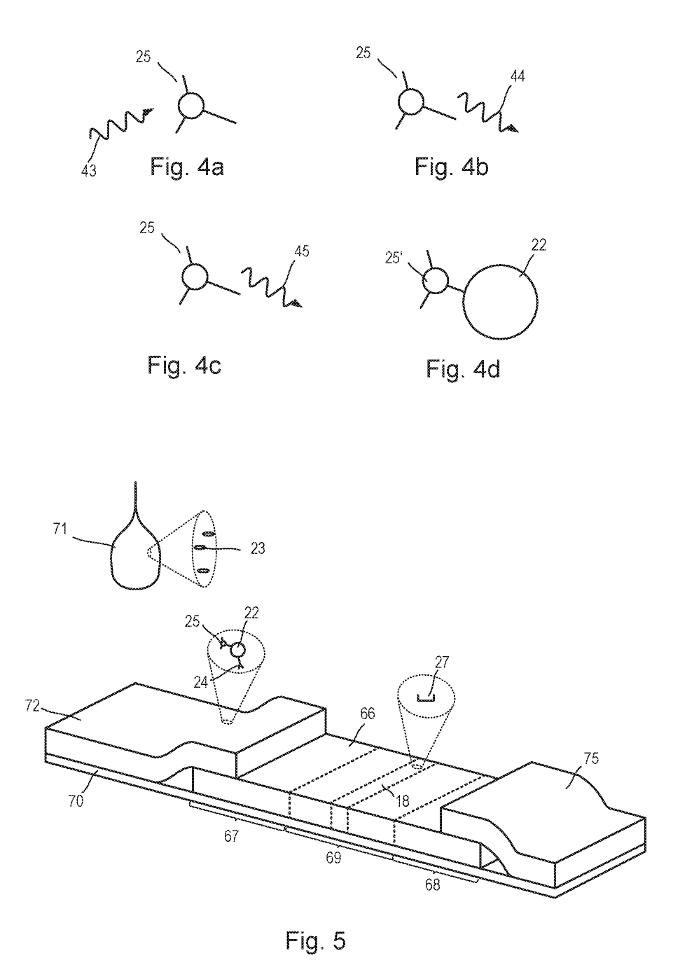

Referring to FIG. 4a, when a molecule 25 undergoes Raman scattering, also known as inelastic scattering, it absorbs an incident photon 43 which has an incident photon frequency f_{inc}. Referring to FIG. 4b, the molecule 25 subsequently emits a Raman photon 44 at an emitted photon frequency f_{Raman}. The emitted Raman photon 44 may have a frequency f_{Stokes} that is smaller than the frequency f_{inc} of the incident photon 43. This is called Stokes scattering. The emitted Raman photon 44 may have a frequency f_{anti-Stokes} that is greater than the frequency f_{inc} of the incident photon 43. This is called anti-Stokes scattering.

Referring to FIG. 4c, the molecule 25 may also undergo resonant, or elastic, scattering. In this case the frequency fᵣₑₛ of an emitted resonant photon 45 is equal to the frequency f_{inc} of the incident photon 43.

Referring to FIG. 4d, a reporter molecule 25′ may be attached to a field-enhancing particle 22. The field-enhancing particle 22 may be a nanoparticle such as a gold nanoparticle. The gold nanoparticle may be, for example, a star-, flower-, raspberry-, urchin-, shell-, disk-, prism-, triangle- or rod-shaped nanoparticle or a generally spherical nanoparticle. The field-enhancing particle 22 may be a silver nanoparticle, a copper nanoparticle, a nickel nanoparticle. The field-enhancing particle 22 may be a nanoparticle which is hollow.

The field-enhancing particle 22 can act to enhance an electric field comprised in excitation light 43. The field-enhancing particle 22 can act to enhance an electric field comprised in scattered light 44, 45. This can increase the intensity of scattered light 44, 45 relative to the intensity of light scattered by a molecule 25 which is not attached to a field-enhancing structure 22.

A reporter molecule 25, 25′ may be any molecule having a Raman active vibrational mode. For example, a reporter molecule may comprise 4-[4-hydroxyphenylazo]pyridine, 4,4′-azopyridine, d8-4,4′-dipyridyl, bis(4-pyridyl)ethylene, bis(4-pyridyl)acetylene, or 4,4′-dipyridyl.

Referring again to FIG. 3, excitation light 41 is scattered by reporter molecules 25. The scattered light 56 is directed towards the first face 6 of the substrate 5.

Referring to FIG. 4c, the scattered light 56 has a spectrum 57 which includes elastically scattered light 58, Stokes-shifted light 59, and anti-Stokes-shifted light 60.

The light-filtering layer 16 comprises a fifth light-blocking region 365. The fifth light-blocking region 36₅ and the fourth light-blocking region 36₄ are arranged to provide the fourth aperture 17₄. The fifth light-blocking region 36₅ and the fourth light-blocking region 36₄ are arranged such that at least a portion 56₁ of scattered light 56 is passed by the fourth aperture 17₄. The portion 56₁ of scattered light 56 includes a portion 58₁ of elastically scattered light 58, a portion 59₁ of Stokes-shifted light 59, and a portion 60₁ of anti-Stokes-shifted light 60.

The first grating element 11 is arranged so as to receive light from the sensing region 15 of the substrate 5 and to direct light towards the second face 7 of the substrate 5. The first grating element 11 includes a grating which is substantially reflective. For example, the first grating element 11 may be a ruled grating or a holographic grating. The first grating element 11 may be a deposited grating, for example a grating which is formed on the first face 6 of the substrate 5 by deposition of a reflective material. The reflective material may be deposited by, for example, a sputtering process or an evaporation process. The reflective material may be deposited by chemical vapour deposition. The first grating element 11 may be an etched grating, that is, a grating which is etched into a reflective coating formed on the first face 6 of the substrate 5. The first grating element 11 may comprise a grating element bonded to the first face 6 of the substrate 5. For example, the first grating element 11 may comprise a holographic grating bonded to the first face 6 of the substrate.

The portion 56₁ of scattered light 56 passed by the fourth aperture 17₁ is incident on the first grating 11. The first grating 11 is a reflection grating having a grating normal 61. The first grating 11 angularly disperses light incident on it. The portion 59₁ of Stokes-shifted light 59 is diffracted by the first grating 11 at a third diffraction angle θ₃ to the grating normal 61. The portion 58₁ of elastically scattered light 58 is diffracted by the first grating 11 at a fourth diffraction angle θ₄ to the grating normal 61. The portion 60₁ of anti-Stokes-shifted light 60 is diffracted by the first grating 11 at a fifth diffraction angle θ₅ to the grating normal 61.

The third diffraction angle θ₃ is less than the fourth diffraction angle θ₄ and the fourth diffraction angle θ₄ is less than the fifth diffraction angle θ₅.

The light-filtering layer 16 comprises a sixth light-blocking region 36₆. The fifth light-blocking region 36₅ and the sixth light-blocking region 36₆ are arranged to provide the fifth aperture 17₅. The fifth light-blocking region 36₅ and the fourth light-blocking region 36₄ are arranged such that the portion 59₁ of Stokes-shifted light 59 is passed by the fifth aperture 17₅. The fifth light-blocking region 36₅ is arranged such that the portion 60₁ of anti-Stokes-shifted light 60 and the portion 58₁ of elastically scattered light 58 are blocked by the fifth light-blocking region 36₅.

The portion 59₁ of Stokes-shifted light 59 is passed by the fifth aperture 175 and is incident on the second reflective element 12.

The second reflective element 12 is carried by the second face 6 of the substrate 4. The second reflective element 12 is arranged so as to receive light from the first grating element 10 and to direct light towards the light detector 9.

The light detector 9 is directed at the second face 7 of the substrate 5 and is arranged so as to receive light from the second reflective element 12.

The second reflective element 12 may comprise a reflective material, for example, silver, aluminium, or titanium. The reflective material may be a conductive material. The reflective material may be a metal. The second reflective element 12 may be formed on the second face 6 of the substrate 4 by deposition of a reflective material. The reflective material may be deposited by, for example, chemical vapour deposition. The second reflective element 12 may be a dielectric mirror. The second reflective element 12 may comprise a reflective element bonded to the second face 6 of the substrate 4.

The portion 59₁ of Stokes-shifted light 59 is reflected by the second reflective element 12 towards the sixth aperture 17₆.

The light-filtering layer 16 comprises a seventh light-blocking region 36₇. The seventh light-blocking region 36₇ and the sixth light-blocking region 36₆ are arranged to provide the sixth aperture 17₆. The seventh light-blocking region 36₇ and the sixth light-blocking region 36₆ are arranged such that the portion 59₁ of Stokes-shifted light 59 is passed by the sixth aperture 17₆. The sixth aperture 17₆ may provide additional spectral filtering of anti-Stokes and resonant components which may have passed through the fifth aperture 17₅.

The portion 59₁ of Stokes-shifted light 59 is passed by the sixth aperture 17₆ and is incident on the light detector 9.

The light detector 9 may comprise an organic photodetector. The light detector 9 may comprise a layer of light-sensitive organic material. The light detector 9 may comprise a silicon photodetector.

The light blocking regions 36₁, 36₂, 36₃, 36₄, 36₅, 36₆, 36₇ may comprise a black ink, for example a carbon black-based ink.

Referring to FIG. 5, the fluidic device 3 may take the form of a first lateral flow device 65. However, as will be explained in the following, the fluidic device 3 may comprise any device providing an analyte binding site, a port and a channel between the port and the analyte binding site for directing a test sample from the port to the analyte binding site, and a field-enhancing particle disposed at or between the port and the analyte binding site, the field-enhancing particle suitable for binding to an analyte. For example, the fluidic device 3 may comprise a flow cell.

The first lateral flow device 65 comprises a generally elongate, strip-like test layer 66. The test layer 66 includes first and second end regions 67, 68 and a test region 69 between first and second end regions 67, 68.

The test layer 66 can hold and transport a liquid sample 71 suspected of containing an analyte 23. The test layer 66 may transport the liquid sample 71 by capillary action (also known as “wicking”). The test layer 66 may be made from one or a combination of materials such as, for example, cellulose filter, nitrocellulose, polyvinylidene fluoride, polyethersulfone (PES), charge modified nylon or surface modified polyester.

The first lateral flow device 65 includes a first conjugate pad 72 in contact with at least a portion of the first end region 67. The first conjugate pad 72 contains a field-enhancing particle 22. A first binding partner 24 capable of binding an analyte 23 is attached to the field-enhancing particle 22. A reporter molecule 25 is attached to the field-enhancing particle 22.

The test region 69 includes an analyte binding site 18. The analyte binding site 18 comprises an immobilised specific binding agent 27. The immobilised binding agent 27 is capable of binding the analyte 22 specifically. For example, if the analyte 22 is an antigen, the immobilised binding agent 27 may be chosen to be an antibody which binds the antigen.

The first lateral flow device 65 includes an absorbent pad 75 in contact with at least a portion of the second end region 68. The absorbent pad 75 comprises one or more absorbent materials such as cotton linter or cellulose. The absorbent pad 75 functions to draw sample fluid through the test layer 66 and functions as a container for fluid drawn through the test layer 66. The absorbent pad 75 is preferably capable of absorbing the entire volume of an applied sample fluid 71 so as to allow the entire volume of the fluid 71 to be drawn through the test layer 66. The absorption capacity of the absorbent pad 75 may be controlled by choice of materials used in the absorbent pad and/or choice of dimensions of the pad.

The first lateral flow device 65 is supported by a transparent backing layer 70. The first lateral flow device 65 may be attached to the transparent backing layer 70 by an adhesive (not shown). The first lateral flow device 65 may be laminated to the transparent backing layer 70.

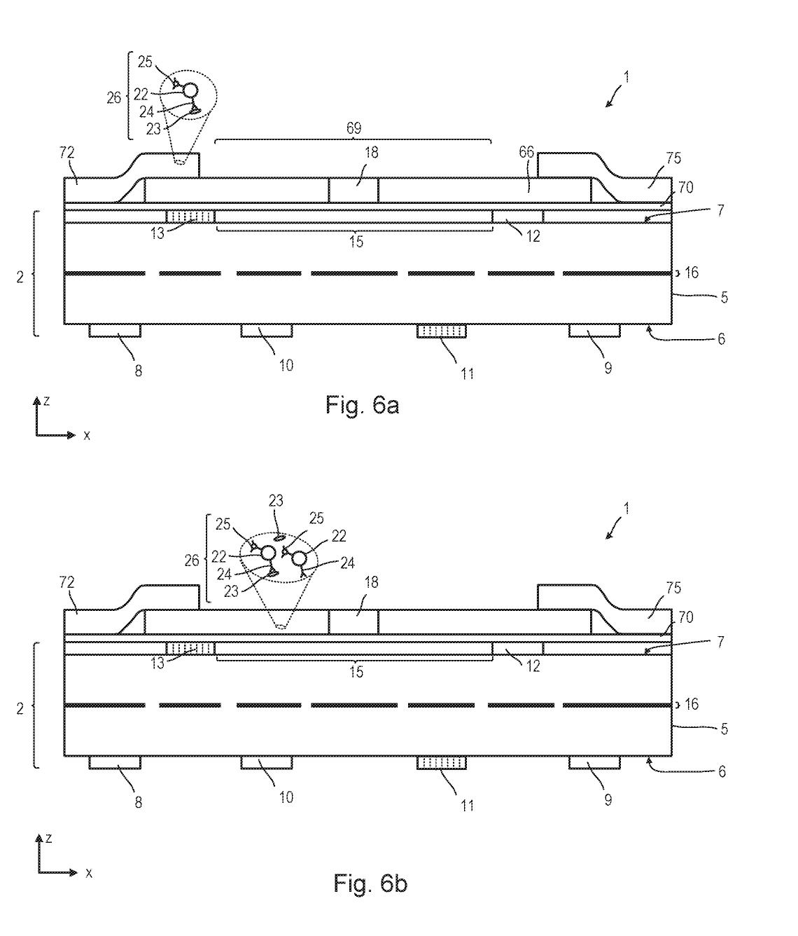

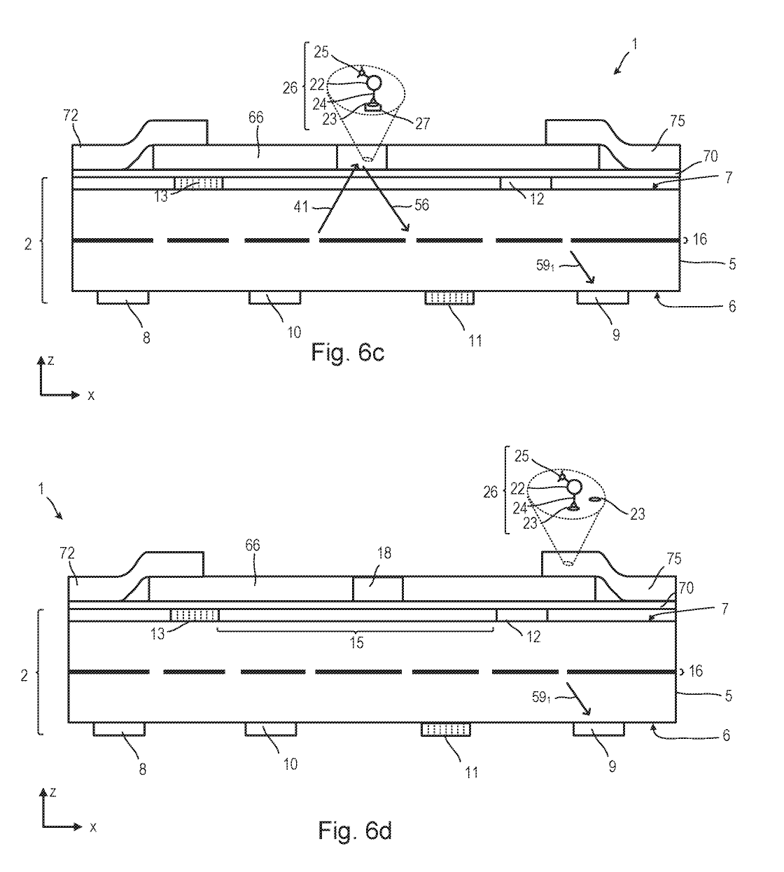

Fluid propagation through the first lateral flow device 65 comprised in a first device 1 for performing Raman spectroscopy will now be described with reference to FIGS. 6a to 6d.

Referring to FIG. 6a, a sensor device 2 is coupled to the first lateral flow device 65 such that the capping layer 42 is next to the transparent backing layer 70 and the analyte binding site 18 is next to the sensing region 15.

Sample fluid 71 (FIG. 5), which is suspected of containing an analyte 22, is applied to the first conjugate pad 72. The first conjugate pad 72 absorbs the sample fluid 71. The sample fluid 71 may dissolve or disperse one or more materials contained by the first conjugate pad 72, for example, a pH buffer or a surfactant. The materials may react with components of the sample fluid and additionally or alternatively may be transported by the fluid 71.

If the sample fluid 71 contains an analyte 23 which is capable of binding to the first binding partner 24, then a binding reaction may occur between the analyte 23 and the first binding partner 24. The sample fluid 71 may then transport bound complexes 26 comprising a first binding partner 24 bound to an analyte 23, the first binding partner 24 being attached to a field-enhancing structure 22, and a reporter molecule 25 being attached to the field-enhancing structure 22.

Referring to FIG. 6b, the sample fluid 71 is drawn into the test layer 66. The sample fluid may transport unbound analyte 23, bound complexes 26, and field-enhancing particles 22 having attached first binding partners 24 and reporter molecules 25.

Referring to FIG. 6c, the sample fluid 71 is drawn through the test layer 66 into the analyte binding site 18. In the analyte binding site 18, a bound complex 26 transported by the sample fluid 71 may bind to an immobilised binding agent 27 and cease to be transported by the sample fluid 71.

A reporter molecule 35 comprised in a bound complex 26 which binds to an immobilised binding agent 27 in the analyte binding site 18 may be excited by excitation light 41 and may emit scattered light 56 through the transparent backing layer 70 and the capping layer 42 into the substrate 5. The scattered light 56 may be filtered by one or more of the fourth, fifth, and sixth apertures 17₄, 17₅, 17₆, and Stokes-shifted light 59₁ may be detected by the detector 9, as described hereinbefore. Detection of Stokes-shifted light 59₁ by the detector 9 can indicate the presence of analyte 23 in the sample fluid 71.

Referring to FIG. 6d, the sample fluid 71 is drawn into the absorbent pad 75.

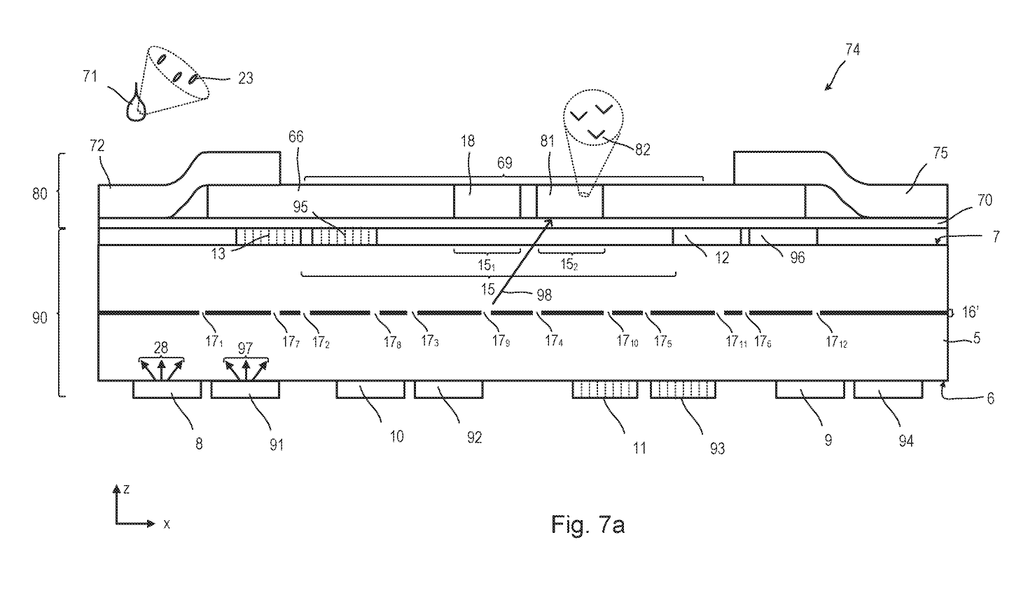

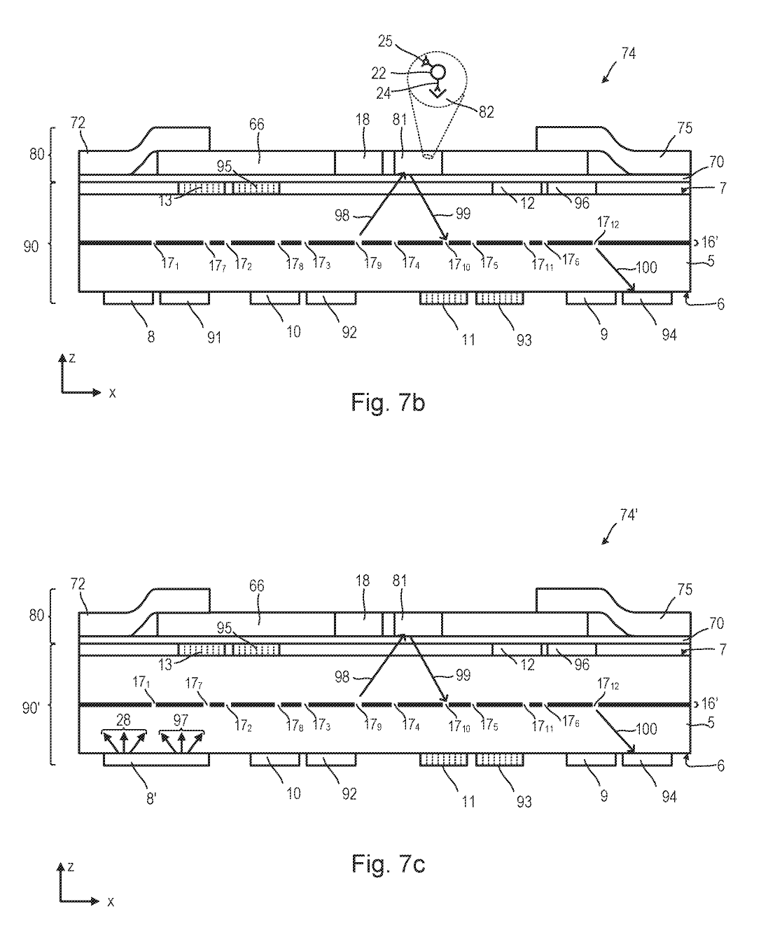

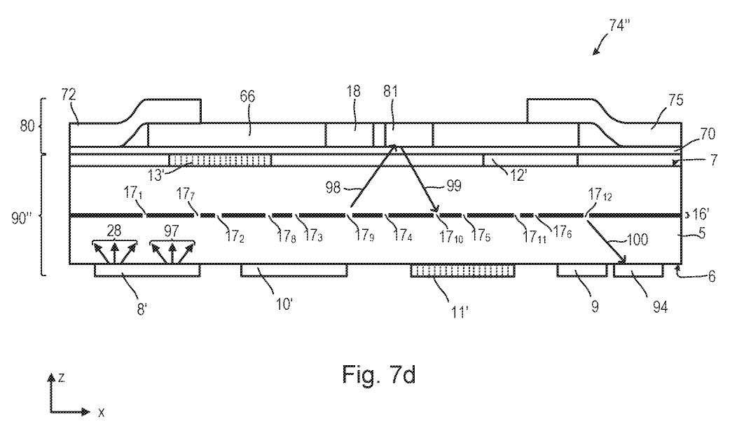

Referring to FIG. 7a, a second device 74 for performing Raman spectroscopy is shown. The second device 74 comprises a second lateral flow device 80 and a second sensor device 90.

The second lateral flow device 80 comprises the test layer 66, test region 69, first conjugate pad 72, and wicking pad 75. The test region 69 comprises the analyte binding site 18. The test region 69 also comprises a reference binding site 81 arranged between the analyte binding site 18 and the wicking pad 75.

The reference binding site 81 includes an immobilised common binding agent 82 which is capable of binding to a first binding partner 24.

The second sensor device 90 comprises the transparent substrate 5, the first and second gratings 11, 13, the light source 8 which is a first light source, the light detector 9 which is a first light detector, the first and second reflective elements 10, 12, the sensing region 15, and the capping layer 42.

The second sensor device 90 is next to the second lateral flow device 80. The second sensor device 90 and the second lateral flow device 80 are arranged such that the analyte binding site 18 and the reference binding site 81 are next to the sensing region 15. The analyte binding site 18 is next to a first region 15₁ of the sensing region 15 and the reference binding site 81 is next to a second region 15₂ of the sensing region 15.

The second sensor device 90 includes a second light source 91 carried by the first face 6 of the substrate 5. The second light source 91 is arranged between the first light source 8 and the first reflective element 10.

The second sensor device 90 includes a third reflective element 92 carried by the first face 6 of the substrate 5. The third reflective element 92 is arranged between the first reflective element 10 and the first grating 11.

The second sensor device 90 includes a third grating 93 carried by the first face 6 of the substrate 5. The third grating 93 is arranged between the first grating 11 and the first light detector 8. The third grating 93 is arranged so as to receive light from the sensing region 15 of the substrate 5 and to direct light towards the second face 7 of the substrate 5.

The second sensor device 90 includes a second light detector 94 carried by the first face 6 of the substrate 5. The first light detector 9 is between the third grating 93 and the second light detector 94.

The second sensor device 90 includes a fourth grating 95 carried by the second face 7 of the substrate 5. The fourth grating 95 is arranged between the second grating 13 and the second reflective element 12. The fourth grating 95 is arranged to receive light from the second light source 91 and to direct light towards the second face 7 of the substrate 5.

The second sensor device 90 includes a fourth reflective element 96 carried by the second face 7 of the substrate 5. The second reflective element 12 is between the fourth grating 95 and the fourth reflective element 96. The fourth reflective element 96 is arranged so as to receive light from the third grating 93 and to direct light towards the second light detector 94. The second light detector 94 is directed at the second face 7 of the substrate 5 and is arranged so as to receive light from the fourth reflective element 96.

The second light source 91 emits second source light 97 towards the second face 7 of the substrate 5.

The second sensor device 90 includes a first modified light filtering layer 16′ disposed in the substrate between the first face 6 and the second face 7. The first modified light-filtering layer 16′ includes the first, second, third, fourth, fifth, and sixth apertures 17₁, 17₂, 17₃, 17₄, 17₅, 17₆. The first modified light-filtering layer 16′ also includes seventh, eighth, ninth, tenth, eleventh and twelfth apertures 17₇, 17₈, 17₉, 17₁₀, 17₁₁, 17₁₂.

The fourth grating 96 and at least one of the seventh, eighth, and ninth apertures 17₇, 17₈, 17₉ act to filter the second source light 97 spectrally and/or spatially in a manner similar to that described hereinbefore in relation to source light 28 emitted by the first light source 8, resulting in second excitation light 98 directed at the second sensing region 15₂ of the substrate 5.

Referring to FIG. 7b, sample fluid 71 applied to the first conjugate pad 72 is drawn through the test layer 66 to the reference binding site 81. As described hereinbefore, sample fluid 71 may transport unbound analyte 23, bound complexes 26, and field-enhancing particles 22 having attached first binding partners 24 and reporter molecules 25. A binding partner 24 attached to a field-enhancing particle 22 may bind to an immobilised common binding agent 82 at the reference binding site 81 and cease to be transported by the sample fluid 71.

A reporter molecule 25 attached to a field-enhancing particle 22 which is immobilised by a common binding agent 82 via a binding partner 24 attached to the field-enhancing particle 22 may be excited by second excitation light 98 and may emit second scattered light 99 through the transparent backing layer 70 and the capping layer 42 into the substrate 5. Second scattered light 99 may be filtered by one or more of the tenth, eleventh, and twelfth apertures 17₁₀, 17₁₁, 17₁₂, and Stokes-shifted light 100 comprised in scattered light 99 may be detected by the second detector 94, in a manner similar to that described hereinbefore in relation to scattered light 56.

A field-enhancing particle 22 which has an attached binding partner 24 and reporter molecule 25 may only be immobilised in the analyte binding site 18 if the binding partner 24 has also bound to an analyte 23. A field-enhancing particle 22 which has an attached binding partner 24 and reporter molecule 25 may be immobilised in the reference binding site 81 regardless of whether the binding partner 24 has also bound to an analyte 23. By comparing the intensity of light received by the first detector 9 and the second detector 94, a quantitative measurement of the presence of analyte 23 in the sample fluid 71 may be performed.

The first source light 28 and the second source light 97 may be emitted by the same light source. Referring to FIG. 7c, a first modified device 74′ for performing Raman spectroscopy comprises the second lateral flow device 80 and a first modified second sensor device 90′. The first modified second sensor device 90′ includes a modified first light source 8′. The second light source 91 (FIG. 7a) is provided by the modified first light source 8′. The modified first light source 8′ emits light including first source light 28 and second source light 97.

Referring to FIG. 7d, a second modified device 74″ for performing Raman spectroscopy comprises the second lateral flow device 80 and a second modified second sensor device 90″. The second modified second sensor device 90″ includes the modified first light source 8′.

The second modified second sensor device 90″ includes a modified second grating element 13′ arranged so as to receive first source light 28 and second source light 97 from the modified first light source 8′ and to direct light towards the first face 6 of the substrate 5.

The second modified second sensor device 90″ includes a modified first reflective element 10′. The modified first reflective element 10′ is arranged so as to receive light from the modified second grating 13′ and to direct light towards the second face 7 of the substrate 5.

The second modified second sensor device 90″ includes a modified first grating element 11′ arranged so as to receive light from the sensing region 15 of the substrate 5 and to direct light towards the second face 7 of the substrate 5. Light from the sensing region 15 includes light from the analyte binding site 18 and light from the reference binding site 81.

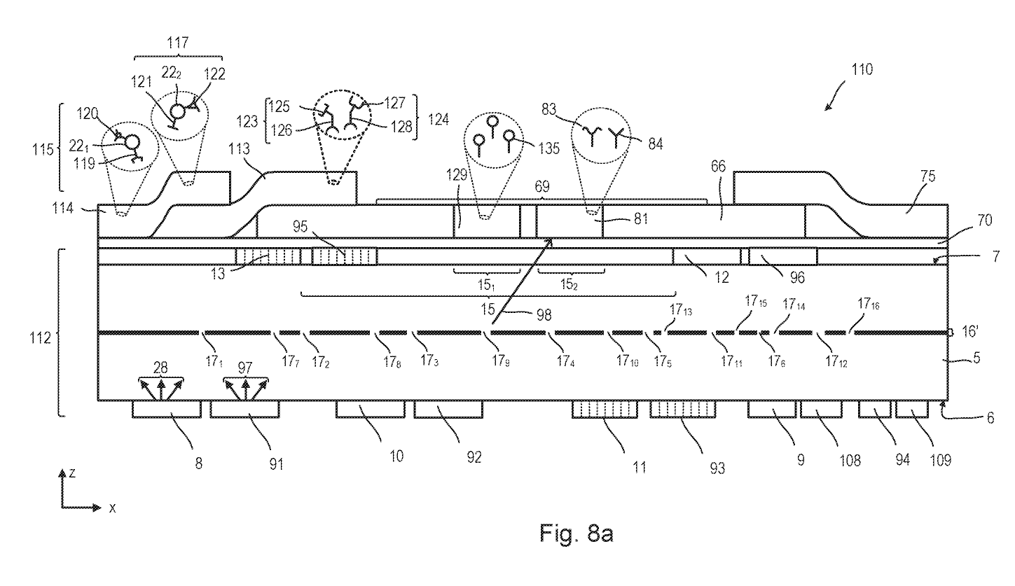

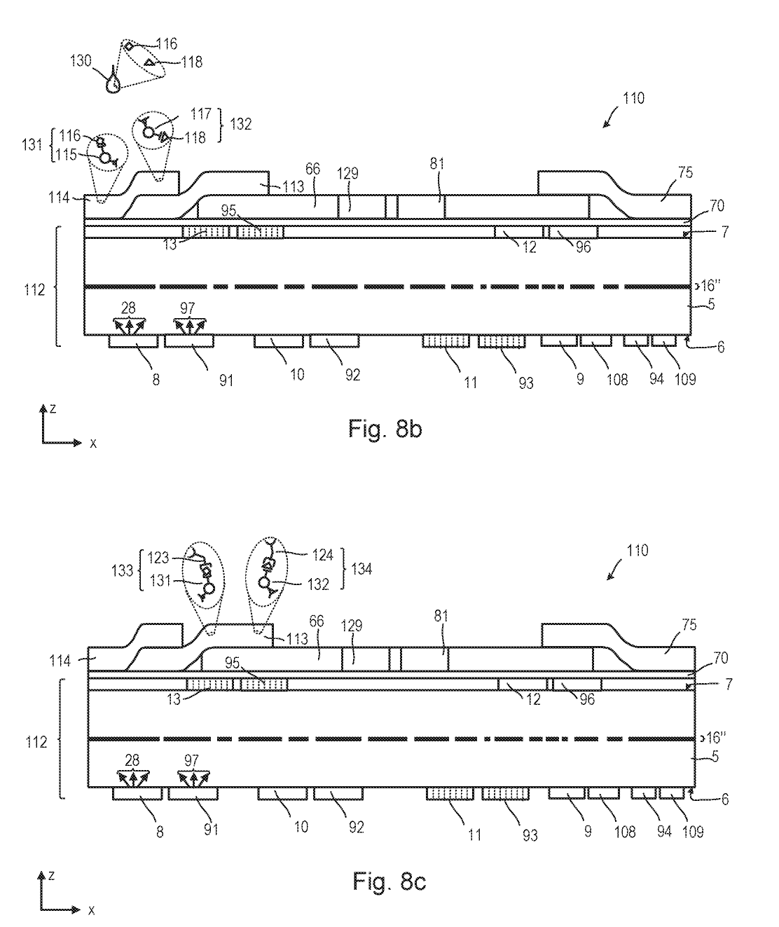

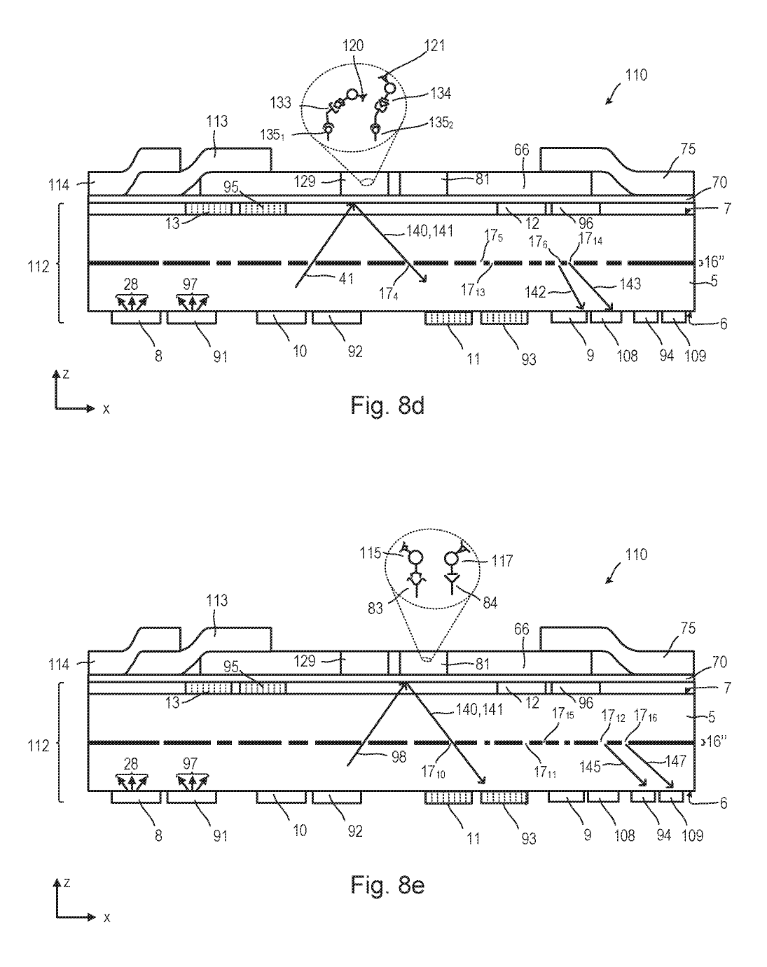

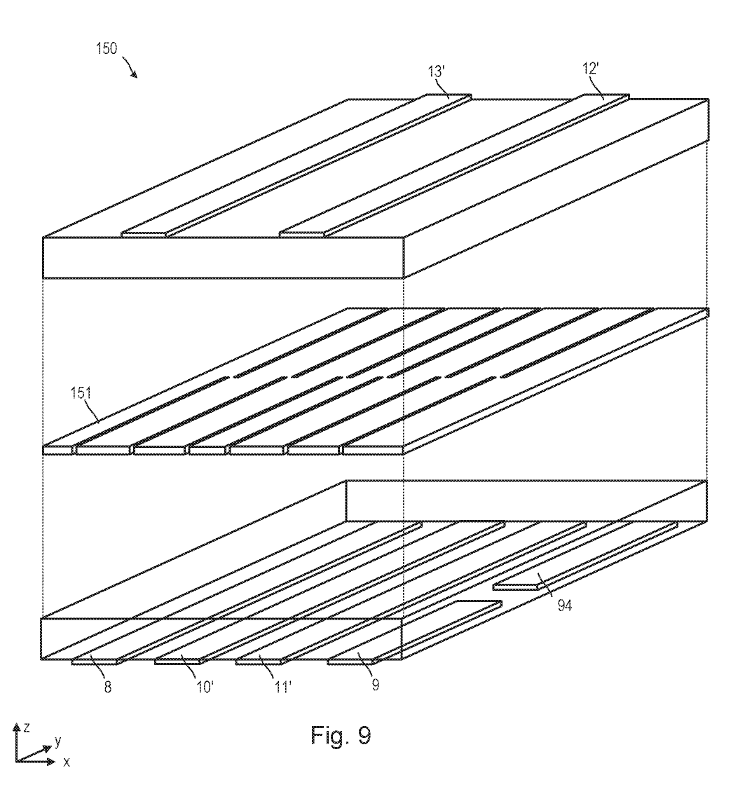

Referring to FIG. 8a, a third device 110 for performing Raman spectroscopy is shown. The third device 110 comprises a third lateral flow device 111 and a third sensor device 112.

The third lateral flow device comprises the test layer 66, test region 69, and wicking pad 75. The third lateral flow device 111 comprises a second conjugate pad 113 in contact with at least a portion of the first end region 67 and a third conjugate pad 114 which is in contact with the second conjugate pad 113 and is not in contact with the test layer 66.

The third lateral flow device 111 can receive a liquid sample 130 (FIG. 8b) suspected of containing a first analyte 116 and a second analyte 118.

The third conjugate pad 114 comprises a first analyte binding structure 115 capable of binding to a first analyte 116. The third conjugate pad 114 comprises a second analyte binding structure 117 capable of binding to a second analyte 118.

The first analyte binding structure 115 comprises a first field-enhancing structure 22₁. A third binding partner 119 capable of binding to the first analyte 116 is attached to the first field-enhancing structure 22₁. A third reporter molecule 120 is attached to the first field-enhancing structure 22₁.

The second analyte binding structure 117 comprises a second field-enhancing structure 22₂. A fourth binding partner 121 capable of binding to the second analyte 118 is attached to the second field-enhancing structure 22₂. A fourth reporter molecule 122 is attached to the second field-enhancing structure 22₂.

The second conjugate pad 113 comprises third and fourth analyte binding structures 123, 124, which are capable of binding to first and second analytes 116, 118 respectively.

The third analyte binding structure 123 comprises a fifth binding partner 125 capable of binding to the first analyte 116. The fifth binding partner 125 is attached to a biotin molecule 126.

The fourth analyte binding structure 124 comprises a sixth binding partner 127 capable of binding to the second analyte 118. The sixth binding partner 127 is attached to a biotin molecule 128.

The test region 69 comprises a reference binding site 81. The test region 69 comprises a generic analyte binding site 129 between the reference binding site 81 and the second conjugate pad 113.

The reference binding site 81 includes a first immobilised common binding agent 83 which is capable of binding to the third binding partner 119. The reference binding site 81 includes a second immobilised common binding agent 84 which is capable of binding to the fourth binding partner 121.

The generic analyte binding site 129 comprises a biotin-binding partner 135. The biotin-binding partner 135 may be, for example, streptavidin, avidin, neutravidin, a polymer formed by one or more of streptavidin, avidin, or neutravidin, an engineered form of streptavidin, avidin, or neutravidin, a biotin binding aptamer. The biotin-binding partner 135 is capable of binding to a biotin molecule 126, 127.

The third sensor device 112 comprises the transparent substrate 5, the first and second gratings 11, 13, the light source 8 which is a first light source, the light detector 9 which is a first light detector, the first and second reflective elements 10, 12, the sensing region 15, and the capping layer 42. The third sensor device 112 comprises the second light source 91, the second light detector 94, the third and fourth reflective elements 92, 96 and the third and fourth gratings 95, 93.

The third sensor device 112 comprises a third light detector 108 carried by the first face 6 of the substrate 5. The third light detector 108 is arranged between the first light detector 9 and the second light detector 94.

The third sensor device 112 comprises a fourth light detector 109 carried by the first face of the substrate 5. The second light detector 94 is between the third light detector 108 and the fourth light detector 109.

The third sensor device 112 includes a second modified light filtering layer 16″ disposed in the substrate between the first face 6 and the second face 7. The second modified light-filtering layer 16″ includes the first, second, third, fourth, fifth, and sixth apertures 17₁, 17₂, 17₃, 17₄, 17₅, 17₆. The second modified light-filtering layer 16″ includes the seventh, eighth, ninth, tenth, eleventh and twelfth apertures 17₇, 17₈, 17₉, 17₁₀, 17₁₁, 17₁₂. The second modified light-filtering layer 16″ also includes a thirteenth aperture 17₁₃ between the fifth aperture 17₅ and the eleventh aperture 17₁₁, and a fourteenth aperture 17₁₄ between the sixth aperture 17₆ and the twelfth aperture 17₁₂. The second modified light-filtering layer 16″ also includes a fifteenth aperture 17₁₅ between the eleventh aperture 17₁₁ and the sixth aperture 17₆, and a sixteenth aperture 17₁₆, wherein the twelfth aperture 17₁₂ is between the fourteenth aperture 17₁₄ and the sixteenth aperture 17₁₆.

Referring to FIG. 8b, a sample fluid 130 is applied to the third conjugate pad 114. In the third conjugate pad 114, a first analyte 116 comprised in the sample fluid 130 may bind to a first analyte binding structure 115 to form a first analyte bound complex 131 and a second analyte 118 comprised in the sample fluid 130 may bind to a second analyte binding structure 117 to form a second analyte bound complex 132. The sample fluid 130 may then transport the first analyte bound complex 131 and the second analyte bound complex 132 through the third conjugate pad 114 and into the second conjugate pad 113.

Referring to FIG. 8c, in the second conjugate pad 113, a first analyte bound complex 131 transported by the sample fluid 130 may bind to a third analyte binding structure 123 to form a third analyte bound complex 133. A second analyte bound complex 132 transported by the sample fluid 130 may bind to a fourth analyte binding structure 124 to form a fourth analyte bound complex 134. First and second analyte binding structures 115, 117 may be transported by the fluid 130 without binding to first and second analytes 116, 118 respectively.

Referring to FIG. 8d, the sample fluid 130 is drawn from the second conjugate pad 113 through the test layer 66 to the generic analyte binding site 129. The sample fluid 130 may transport third and fourth analyte binding structures 133, 134. The sample fluid 130 may transport first and second analyte binding structures 115, 117.

At the generic analyte binding site 129, the biotin molecule 126 comprised in a third analyte binding structure 123 which is comprised in a third analyte bound complex 133 may bind to a first immobilised biotin-binding partner 135₁ and cease to be transported by the sample fluid 130. The biotin molecule 127 comprised in a fourth binding structure 124 which is comprised in a fourth analyte bound complex 134 may bind to an second immobilised biotin-binding partner 135₂ and cease to be transported by the sample fluid 130.

A third reporter molecule 120 comprised in a third analyte bound complex 133 which is immobilised by a biotin-binding partner 135 may be excited by excitation light 41 and may emit third scattered light 140 through the transparent backing layer 70 and the capping layer 42 into the substrate 5. Third scattered light 140 may be filtered by one or more of the fourth, fifth, and sixth apertures 17₄, 17₅, 17₆, and third Stokes-shifted light 142 centred on a third Stokes wavelength λ₃ comprised in third scattered light 140 may be detected by the first detector 9, in a manner similar to that described hereinbefore in relation to scattered light 56.

A fourth reporter molecule 122 comprised in a fourth analyte bound complex 134 which is immobilised by a biotin-binding partner 135 may be excited by excitation light 41 and may emit fourth scattered light 141 through the transparent backing layer 70 and the capping layer 42 into the substrate 5. Fourth scattered light 141 may be filtered by one or more of the fourth, thirteenth, and fourteenth apertures 17₄, 17₁₃, 17₁₄, and fourth Stokes-shifted light 143 centred on a fourth Stokes wavelength λ₄ comprised in fourth scattered light 141 may be detected by the third detector 108, in a manner similar to that described hereinbefore in relation to scattered light 56.

The third Stokes wavelength λ₃ is in general different to the fourth Stokes wavelength λ₄. This can allow more than one analyte present in sample 130 to be detected.

Referring to FIG. 8e, a first binding partner 119 attached to a first field-enhancing particle 22₁ may bind to a first immobilised common binding agent 83 at the reference binding site 81 and cease to be transported by the sample fluid 130. A second binding partner 121 attached to a second field-enhancing particle 22₂ may bind to a second immobilised common binding agent 84 at the reference binding site 81 and cease to be transported by the sample fluid 130.

A third reporter molecule 120 immobilised at the reference binding site 81 may be excited by excitation light 98 and may emit fifth scattered light 144 through the transparent backing layer 70 and the capping layer 42 into the substrate 5. Fifth scattered light 144 may be filtered by one or more of the tenth, eleventh, and twelfth apertures 17₁₀, 17₁₁, 17₁₂, and fifth Stokes-shifted light 145 centred on a third Stokes wavelength λ₃ comprised in fifth scattered light 144 may be detected by the second detector 94, in a manner similar to that described hereinbefore in relation to scattered light 99.

A fourth reporter molecule 122 immobilised at the reference binding site 81 may be excited by excitation light 98 and may emit sixth scattered light 146 through the transparent backing layer 70 and the capping layer 42 into the substrate 5. Sixth scattered light 146 may be filtered by one or more of the tenth, fifteenth, and sixteenth apertures 17₁₀, 17₁₅, 17₁₆, and sixth Stokes-shifted light 147 centred on a fourth Stokes wavelength λ₄ comprised in sixth scattered light 146 may be detected by the third detector 109, in a manner similar to that described hereinbefore in relation to scattered light 56.

Thus, more than one analyte may be tested for in a single fluid sample. Two or more fluid samples, each containing a different analyte, may be applied to the same lateral flow device 111 comprised in device 110 and the presence and optionally concentration of each analyte may be measured. Separation of the fluid samples may not be required, for example, the fluid samples need not be applied to different areas of the lateral flow device 111, and separate flow channels within the lateral flow device 111 need not be provided.

Referring again FIG. 7a, the first conjugate pad 72 and the absorbent pad 75 are spaced apart in a first direction which lies in a plane which is parallel to the plane of the substrate. The first detector 9 and the second detector 94 are spaced apart in the first direction in the plane of the substrate.

Referring to FIG. 9, a fourth sensor device 150 comprises the first detector 9, the second detector 94, the first light source 8, the modified first and second grating elements 11′, 13′ (FIG. 7c), and the modified first and second reflective elements 10′, 12′ (FIG. 7c). The first detector 9 and the second detector 94 are spaced apart in a second direction in the plane of the substrate. The second direction is substantially perpendicular to the first direction. The fourth sensor device 150 comprises a second light-filtering layer 151.

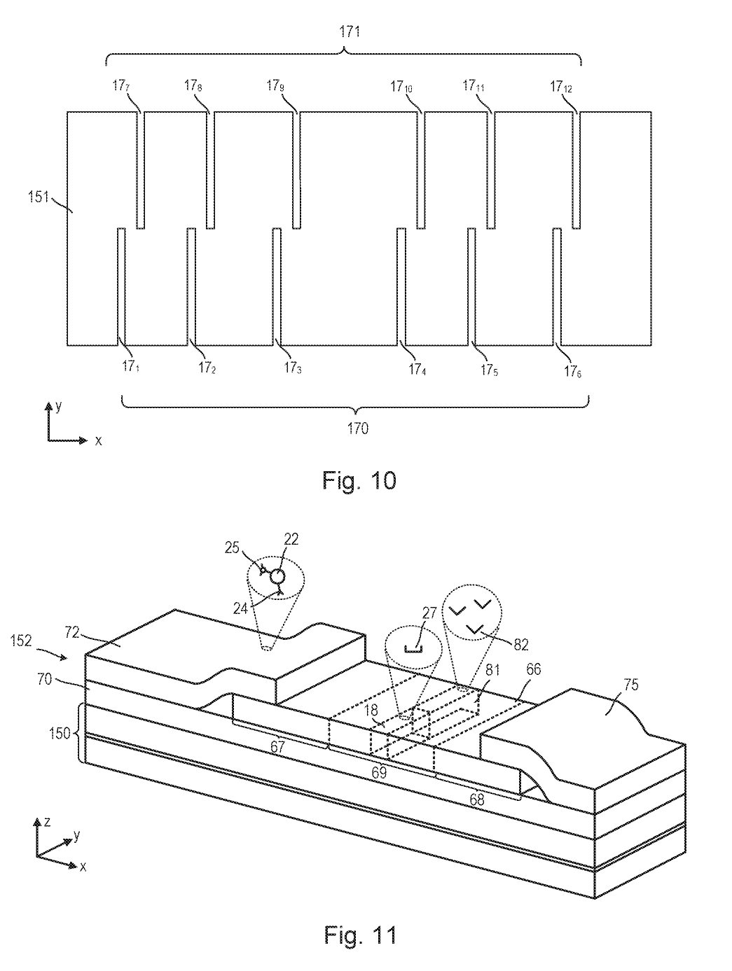

Referring also to FIG. 10, the second light filtering layer 151 includes a first group of apertures 170 including the first, second, third, fourth, fifth, and sixth apertures 17₁, 17₂, 17₃, 17₄, 17₅, 17₆ and a second group of apertures 171 including the seventh, eighth, ninth, tenth, eleventh, and twelfth apertures 17₇, 17₈, 17₉, 17₁₀, 17₁₁, 17₁₂. The first group of apertures 170 is spaced apart from the second group of apertures 171 in the second direction.

Referring to FIG. 11, a fourth device 160 for performing Raman spectroscopy includes the fourth sensor device 150 and a fourth lateral flow device 152.

The fourth lateral flow device 152 includes the first conjugate pad 72, transparent backing layer 70, absorbent pad 75, and test layer 66 including the first and second end regions 67, 68 and the test region 69 between first and second end regions 67, 68. The first and second end regions 67, 68 are spaced apart in the first direction. The test layer 66 includes the analyte binding site 18 and the reference binding site 81. The analyte binding site 18 and the reference binding site 81 are spaced apart in the second direction.

By providing appropriate sets of apertures and detectors, multiplexing of binding sites is possible in the first direction and in the second direction. This can allow tests for multiple analytes to be performed using a single device for performing Raman spectroscopy. Multiple fluid samples containing multiple analytes may be tested using the same device at the same time.

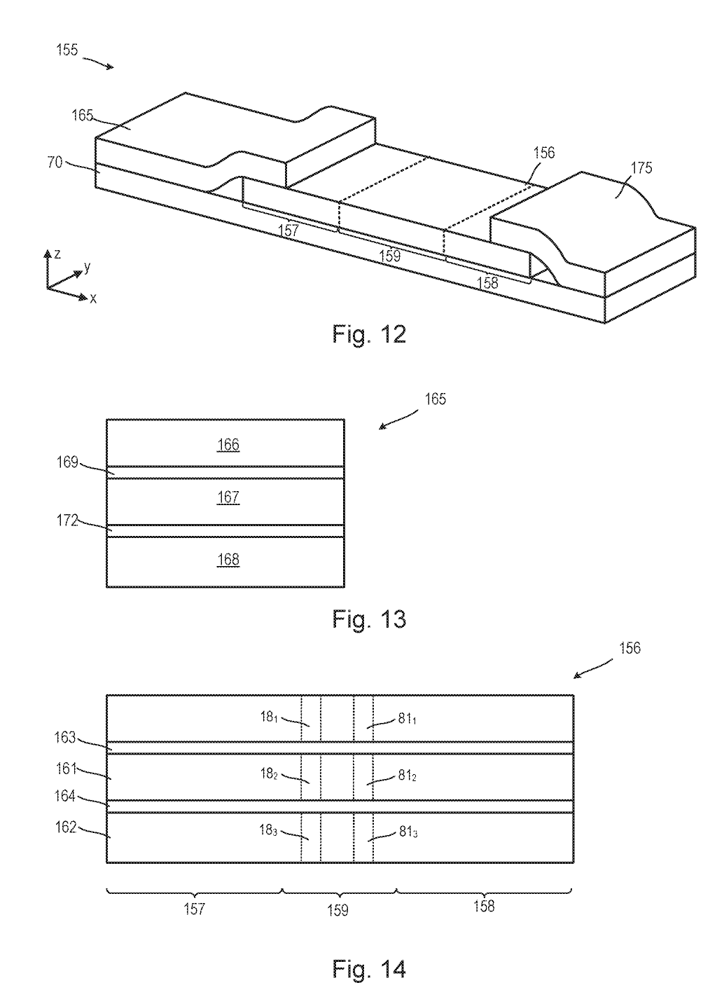

Referring to FIG. 12, a fifth lateral flow device 155 includes a test layer 156, a fifth conjugate pad 165, an absorbent pad 175, and transparent backing layer 70.

Referring to FIG. 13, the fifth conjugate pad 165 includes first, second, and third regions 166, 167, 168. The first, second, and third regions 166, 167, 168 extend in the first direction and are spaced apart in a second direction which is in the plane of the test layer 156 and is perpendicular to the first direction. The first region 166 and the second region 167 are spaced apart by a fourth barrier 169. The second region 167 and the third region 168 are spaced apart by a fifth barrier 172.

The first region 166 contains a first field-enhancing particle 173₁ attached to a first binding partner 174₁ capable of binding a first analyte (not shown). A first reporter molecule 175₁ is attached to the first field-enhancing particle 173₁.

The second region 167 contains a second field-enhancing particle 173₂ attached to a second binding partner 174₂ capable of binding a second analyte (not shown). A second reporter molecule 175₁ is attached to the second field-enhancing particle 173₂.

The third region 168 contains a third field-enhancing particle 173₃ attached to a third binding partner 174₃ capable of binding a third analyte (not shown). A third reporter molecule 175₃ is attached to the third field-enhancing particle 173₃.

Referring also to FIG. 14, the test layer 156 has a first end region 157 and a second end region 158. The first end region 157 and the second end region 158 are spaced apart in a first direction. The test layer has a test region 159 between the first end region 157 and the second end region 158. The test layer 156 includes first, second, and third channels 160, 161, 162. The first, second, and third channels 160, 161, 162 extend in the first direction and are spaced apart in a second direction which is in the plane of the test layer 156 and is perpendicular to the first direction. The first channel 160 and the second channel 161 are spaced apart by a first channel barrier 163. The second channel 161 and the third channel 162 are spaced apart by a second channel barrier 164.

The first and second channel barriers 163, 164 are arranged to provide barriers between fluids flowing in adjacent channels. The first and second channel barriers 163, 164 may comprise regions of obstructed pores of the test layer 156. The first and second channel barriers 163, 164 may comprise hydrophobic regions. For example, if the test layer 156 comprises nitrocellulose or paper, hydrophobic regions may be created by printing or patterning hydrophobic agents such as paraffin, photoresists, polydimethylsiloxane (PDMS), polystyrene, wax or by plasma treatment.

The first channel 160 includes a first analyte binding site 18₁ and a first reference binding site 81₁. The first analyte binding site 18₁ and the first reference binding site 81₁ are spaced apart in the first direction. The first analyte binding site 18₁ includes a fourth binding partner capable of binding to the first analyte. The first reference binding site 81₁ includes a fifth binding partner capable of binding to the first binding partner.

The second channel 160 includes a second analyte binding site 18₂ and a second reference binding site 81₂. The second analyte binding site 18₂ and the second reference binding site 81₂ are spaced apart in the first direction. The second analyte binding site 18₂ includes a sixth binding partner capable of binding to the second analyte. The second reference binding site 81₂ includes a seventh binding partner capable of binding to the second binding partner.

The third channel 160 includes a third analyte binding site 18₃ and a third reference binding site 81₃. The third analyte binding site 18₃ and the third reference binding site 81₃ are spaced apart in the first direction. The third analyte binding site 18₁ includes an eighth binding partner capable of binding to the third analyte. The third reference binding site 81₃ includes a ninth binding partner capable of binding to the third binding partner.

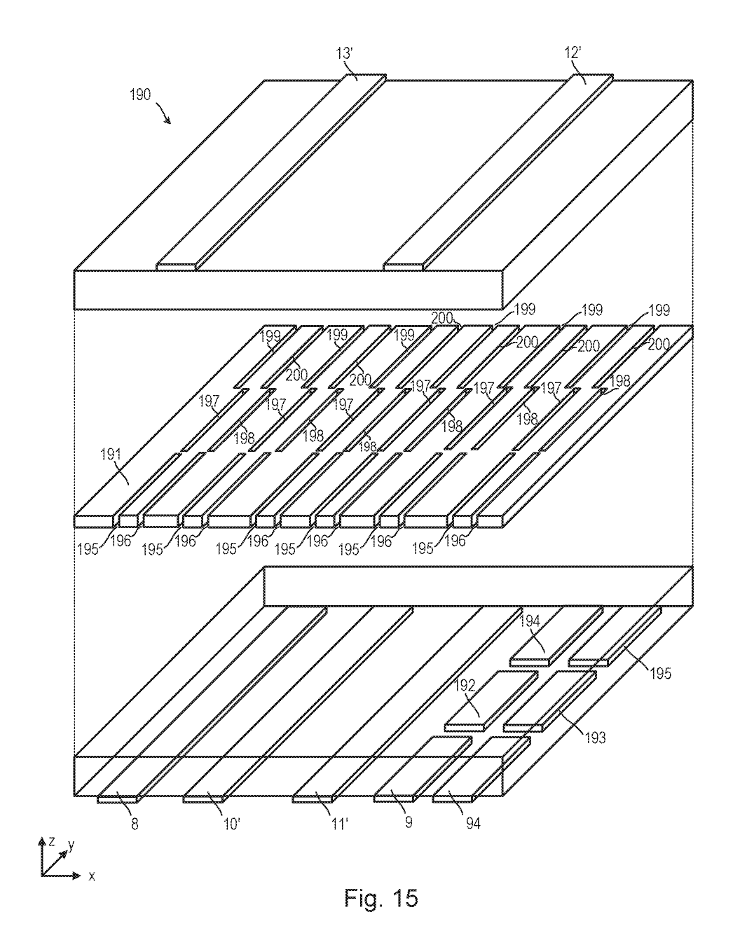

Referring to FIG. 15, a fifth sensor device 190 includes the first detector 9, the second detector 94, the first light source 8, the modified first and second grating elements 11′, 13′, and the modified first and second reflective elements 10′, 12′. The first detector 9 and the second detector 94 are spaced apart in the first direction in the plane of the substrate. The fifth sensor device 190 comprises a third light-filtering layer 191.

The fifth sensor device 190 includes a fifth detector 192 and a sixth detector 193. The fifth detector 192 and the sixth detector 193 are spaced apart in the first direction.

The fifth sensor device includes a seventh detector 194 and an eighth detector 195. The seventh detector 194 and the eighth detector 195 are spaced apart in the first direction.

The first detector 9, the fifth detector 192, and the seventh detector 194 are spaced apart in the second direction. The second detector 94, the sixth detector 193, and the eighth detector 195 are spaced apart in the second direction.

The third light filtering layer 191 includes a third group of apertures 192, a fourth group of apertures 193, and a fifth group of apertures 194. The third, fourth, and fifth groups of apertures 192, 193, 194 are spaced apart in the second direction in the plane of the substrate.

The third group of apertures 192 includes a first subgroup of apertures 195 arranged to filter light emitted by the first light source 8 and light received from the first analyte binding site 18₁ (FIG. 14), in a manner similar to that described hereinbefore in relation to scattered light 56. The third group of apertures 192 includes a second subgroup of apertures 196 arranged to filter light emitted by the first light source 8 and light received from the first reference binding site 81₁ (FIG. 14), in a manner similar to that described hereinbefore in relation to scattered light 99.

The third group of apertures 192 includes a third subgroup of apertures 197 arranged to filter light emitted by the first light source 8 and light received from the second analyte binding site 18₂ (FIG. 14), in a manner similar to that described hereinbefore in relation to scattered light 56. The third group of apertures 192 includes a fourth subgroup of apertures 198 arranged to filter light emitted by the first light source 8 and light received from the second reference binding site 81₂ (FIG. 14), in a manner similar to that described hereinbefore in relation to scattered light 99.

The third group of apertures 192 includes a fifth subgroup of apertures 199 arranged to filter light emitted by the first light source 8 and light received from the third analyte binding site 18₃ (FIG. 14), in a manner similar to that described hereinbefore in relation to scattered light 56. The third group of apertures 192 includes a sixth subgroup of apertures 200 arranged to filter light emitted by the first light source 8 and light received from the third reference binding site 81₃ (FIG. 14), in a manner similar to that described hereinbefore in relation to scattered light 99.

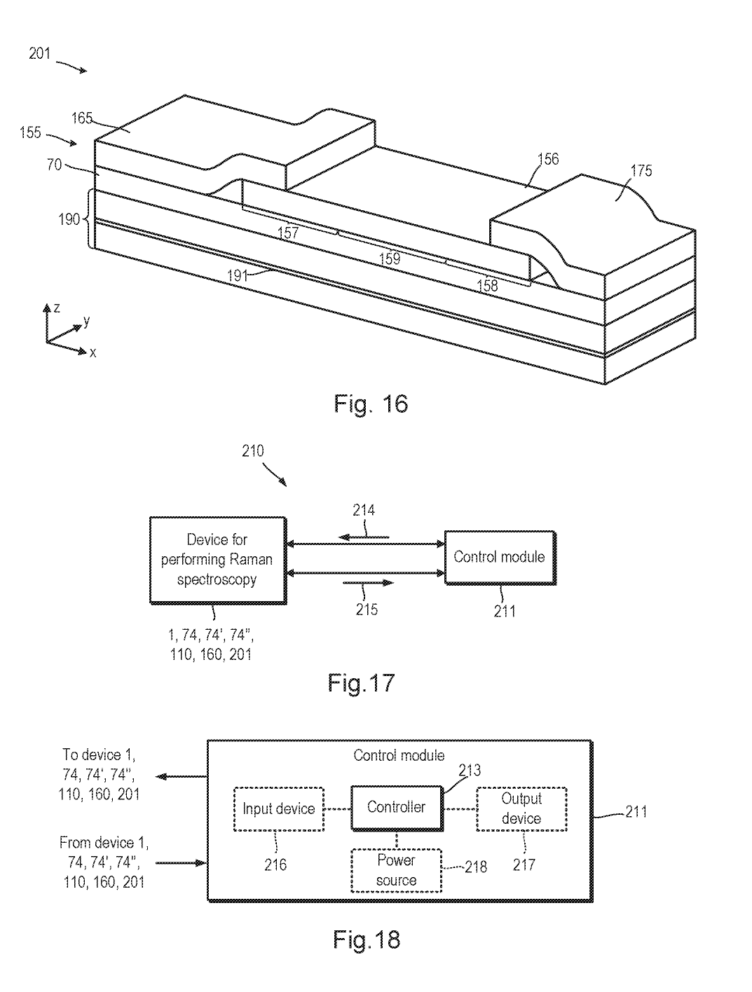

Referring to FIG. 16, a fifth device 201 for performing Raman spectroscopy includes the fifth sensor device 190 and the fifth lateral flow device 155. The fifth sensor device 190 is arranged next to the fifth lateral flow device 155.

First, second, and third sample fluids (not shown) suspected of containing first, second and third analytes respectively may be applied to first, second and third regions respectively. Thus a single device 201 can be used to test multiple sample fluids for multiple analytes.

Referring to FIG. 17, apparatus 210 comprises a device for performing Raman spectroscopy 1, 74, 74′, 74″, 110, 160, 201 and a control module 211. The control module 211 includes a controller 212, for example in the form of a microprocessor or microcontroller. The controller 213 is configured to drive either directly or indirectly (in other words, via an external driver), the light source 8, 8′, 91 with an input signal 214 and receive an output signal 215 from the light detector 9, 94, 108, 109 which may be pre-processed (for example amplified, filtered and/or integrated by a front-end circuit).

If the Raman spectroscopy device comprises more than one light source, the controller 213 may be configured to apply a separate input signal to each light source. If the Raman spectroscopy device comprises more than one light detector, the controller 213 may be configured to receive a separate output signal from each light detector.

Referring also to FIG. 17, the control module 211 optionally includes a user input device 216 for allowing a user (not shown) to control a measurement (e.g. start the measurement), an output device 217 for signalling a result of the measurement and a power source 218. The power source 218 may include a power store (such as a battery) and/or energy-harvesting device (such as a photovoltaic cell) thereby allowing the apparatus 210 to be used without the need to be connected to an external electrical source (such as mains power or communications bus). The control module 211 may include or be provided with a network interface (not shown) which may be wired or wireless for allowing the apparatus 210 to be remotely deployed, for example, from point of data collection and analysis.

Modifications

It will be appreciated that various modifications may be made to the embodiments hereinbefore described. Such modifications may involve equivalent and other features which are already known in the design, manufacture and use of devices for performing Raman spectroscopy and component parts thereof and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

The analyte may function as a first reporter molecule, for example, an analyte having a Raman active vibrational mode may function as a first reporter molecule. Preferably, an analyte has a strong Raman active mode. The analyte may be a biological analyte, for example, troponin I. A first conjugate pad may include a field-enhancing structure attached to a first binding partner capable of binding to an analyte. An analyte binding site may comprise an immobilised second binding partner capable of binding to the analyte. A reference binding site may comprise an immobilised common binding partner capable of binding to the first binding partner. An immobilised common binding partner may function as a second reporter molecule and provide a reference signal. An immobilised common binding partner which may function as a second reporter molecule may be, for example, an antibody, a peptide, an aptamer (peptide or nucleic acid) or a nucleic acid sequence.

The reporter molecule may be provided separately to the field-enhancing structure. For example, the reporter molecule and the field-enhancing structure may be dried on to the conjugate pad and may combine when wetted, for example by a sample fluid.

In any of the embodiments described herein, an optical path between a grating and corresponding analyte or reference binding region may include a single aperture provided by a first pair of light blocking regions. An optical path between a grating and a corresponding light detector may include a single aperture provided by a second pair of light blocking regions. For example, referring again to FIG. 8a, in an optical path between grating 11 and corresponding light detectors 9, 108, only light blocking regions providing apertures 17₆, 17₁₄ may be provided. In an optical path between grating 93 and corresponding light detectors 94, 109, only light blocking regions providing apertures 17₁₂, 17₁₆ may be provided. In an optical path between grating 13 and binding region 129, only light blocking regions providing aperture 17₃ may be provided. In an optical path between grating 95 and binding region 81, only light blocking regions providing aperture 17₉ may be provided. The remaining light blocking regions may not be provided.

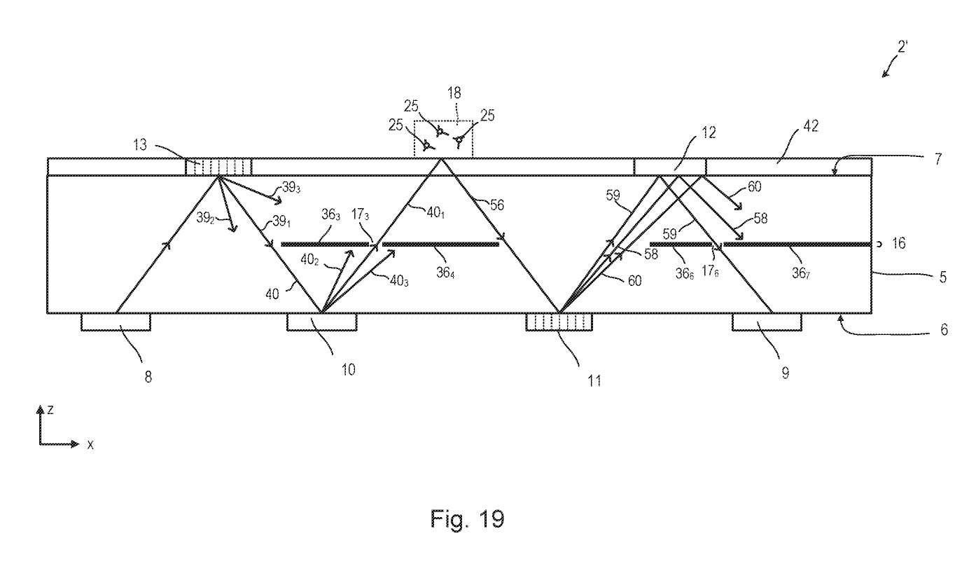

By way of example, referring to FIG. 19, a first modified sensor device 2′ is shown. The first modified sensor device 2′ is similar to the sensor device 2 in all respects except that the first, second, and fifth light blocking regions 36₁, 36₂, 36₅ are not provided. The sixth and seventh light blocking regions 36₆, 36₇ form a first pair of light blocking regions arranged to provide aperture 17₆ in an optical path between the grating 11 and detector 9. As described hereinbefore, scattered light 56 includes elastically scattered light 58, Stokes-shifted light 59, and anti-Stokes-shifted light 60. The sixth aperture 17₆ passes Stokes-shifted light 59. Elastically scattered light 58 and anti-Stokes-shifted light 60 are blocked by sixth light blocking region 36₆ and/or seventh light blocking region 36₇.

The third and fourth light blocking regions 36₃, 36₄ form a second pair of light blocking regions arranged to provide aperture 17₃ in an optical path between the second grating 13 and the analyte binding site 18. As described hereinbefore, the third aperture 17₃ passes a first portion 40₁ of source light 40 which has a narrower range of frequencies than filtered source light 40. Second and third portions 40₂, 40₃ of source light 40 are blocked by the third light-blocking region 36₃ and/or the fourth light-blocking region 36₄ respectively.

In any of the embodiments described herein, a further aperture may be provided in an optical path to provide additional spectral filtering.

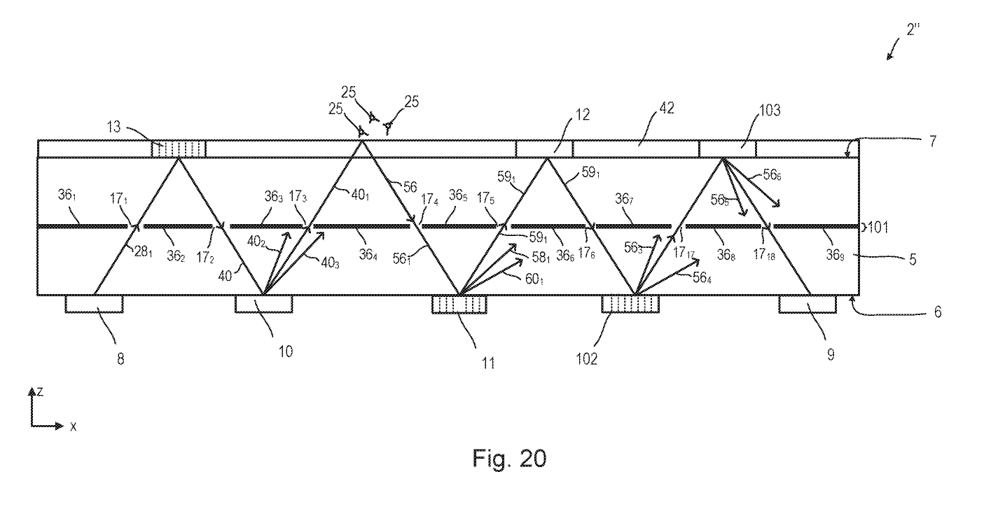

By way of example, referring to FIG. 20, a second modified sensor device 2″ is shown. The second modified sensor device 2″ includes the transparent substrate 5 having first and second opposite faces 6, 7. The first face carries light source 8, first reflective element 10, first grating 11, and light detector 9. The second face carries second grating 13 and second reflective element 12.

The second modified sensor device 2″ includes a fifth grating 102 carried by the first face 6 of the substrate 5. The fifth grating 102 is between the first grating 11 and the detector 9. The fifth grating 102 is arranged to receive light from the second reflective element 12 and to direct light towards the second face 7.

The second modified sensor device 2″ includes a fifth reflective element 103 carried by the second face 7 of the substrate 5. The second reflective element 12 is between the fifth reflective element 103 and the second grating 13. The fifth reflective element 103 is arranged to receive light from the fifth grating and to direct light towards the first face 6 of the substrate 5.

The second modified sensor device 2″ includes a light filtering layer 101 having first, second, third, fourth, fifth, sixth, and seventh light blocking regions as described hereinbefore. The light filtering layer 101 includes eighth and ninth light blocking regions 36₈, 36₉.

The seventh and eighth light blocking regions 36₇, 36₈ are arranged to provide a seventeenth aperture 17₁₇ in an optical path between the fifth grating 102 and the fifth reflective element. The eighth and ninth light blocking regions are arranged to provide an eighteenth aperture 17₁₈ in an optical path between the fifth reflective element 103 and the light detector 9.

The seventeenth and eighteenth apertures can help to provide further spectral filtering of scattered light 56. For example, scattered light portions 56₃, 56₄ may be blocked by the seventh and/or the eighth light blocking regions 36₇, 36₈ respectively. Scattered light portions 56₅, 56₆ may be blocked by the eighth and/or the ninth light blocking regions 36₈, 36₉ respectively.

Referring to FIG. 21, the substrate 5 may comprise a first substrate 5₁ and a second substrate 5₂. The first substrate has first and second opposite faces 6₁, 7₁. The second substrate 5₂ has first and second opposite faces 6₂, 7₂. The first substrate 5₁ and the second substrate 5₂ may be joined together such that the second face 7₁ of the first substrate 51 faces the first face 6₂ of the second substrate 5₂. The first substrate 5₁ and the second substrate 5₂ may be held together using an adhesive (not shown), for example, an optically clear adhesive, a UV-curable epoxy. The adhesive is preferably index-matched with the first substrate 5₁ and the second substrate 5₂.

The first face 6 of the substrate 5 is then provided by the first face 6₁ of the first substrate 5₁. The second face 7 of the substrate 5 is provided by the second face 7₂ of the second substrate 5₂.

A light filtering layer 16 may be carried by the second face 7₁ of the first substrate 5₁. The light blocking regions 36 of the light filtering layer 16 may be formed by screen printing, inkjet printing, or by a combination of spin coating and optical lithography.

The light filtering layer 16 may alternatively be carried by the first face 6₂ of the second substrate 5₂.

The fluidic device need not be a lateral flow device. For example, the fluidic device may be a microfluidic well or a microfluidic channel or flow cell.

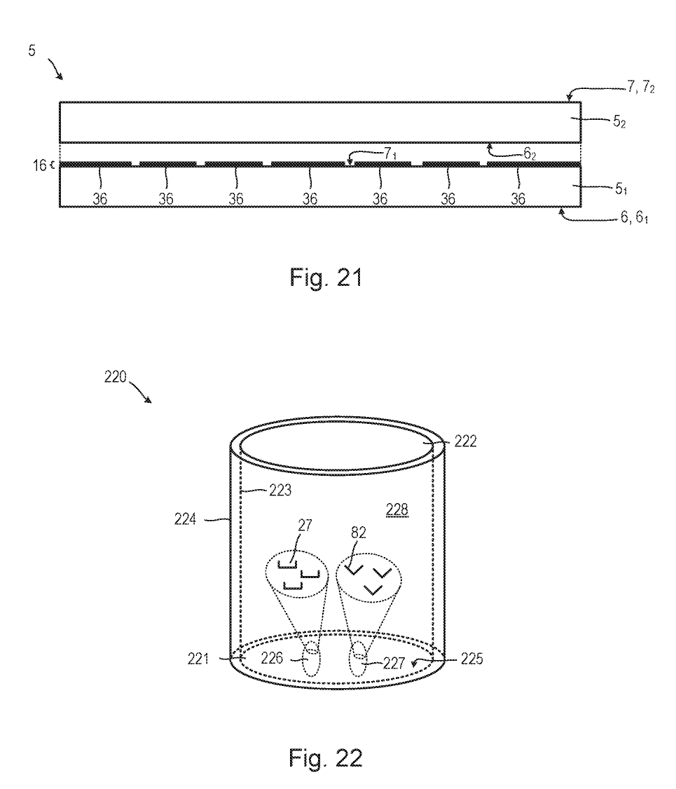

Referring to FIG. 22, a microfluidic well 220 (or simply “well”) is shown which is generally cylindrical in shape with a closed first end 221 and an open second end or port 222. The well 220 comprises an optically transparent material, for example, polystyrene or polyvinyl chloride. The well has an inner surface 223 and an outer surface 224.

The inner surface 223 includes an inner base area 225 which is generally circular in shape at the first end 221. The inner base area 225 includes an analyte binding site 226 and a reference binding site 227. The analyte binding site 226 is spaced apart from the reference binding site 227.

The well 220 can hold a liquid sample 71 suspected of containing an analyte 23. The well 220 can hold a solution 231 including a first binding partner 24 capable of binding the analyte 23. The first binding partner 23 is attached to a field-enhancing particle 22. A first reporter molecule 25 is attached to the field-enhancing particle 22.

A second analyte binding partner 27 which is capable of binding to analyte 23 is disposed at the analyte binding site 226 and an immobilised common binding partner 82 which is capable of binding to a first binding partner 24 is disposed at the reference binding site 227. The first end and the second end are spaced apart by an intervening region 228 providing a channel between the port 222 and the analyte binding site 226 and reference binding site 227.

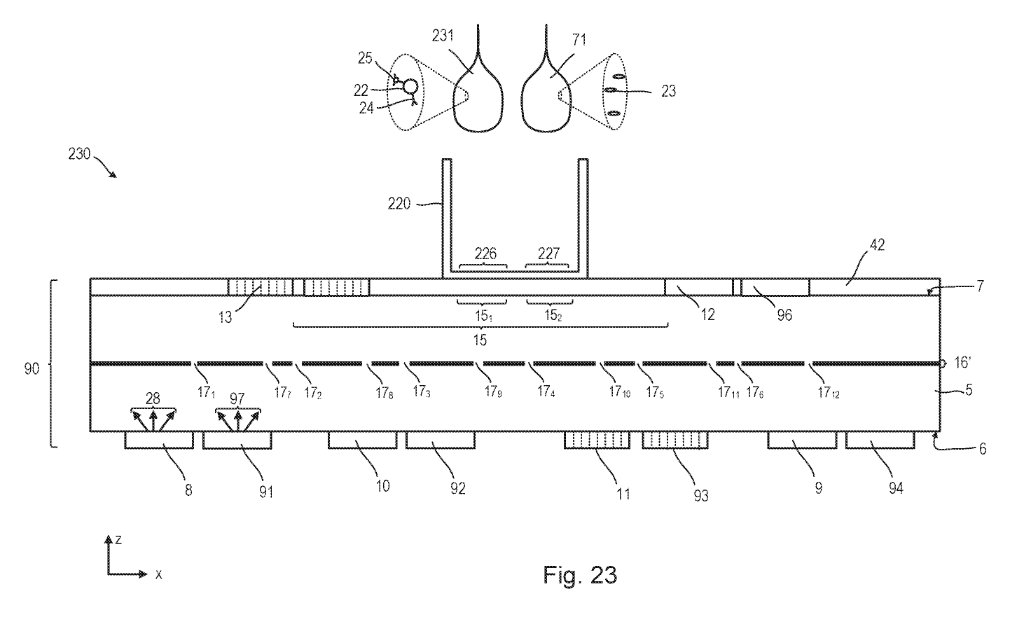

Referring to FIG. 23, a sixth device for performing Raman spectroscopy 230 comprises the well 220 and the second sensor device 90. The well 220 is coupled to the second sensor device 90 next to the second face 7 of the sensor device 90. The well 220 is supported by the capping layer 42. The analyte binding site 226 is next to the first region 15₁ of the sensing region 15 and the reference binding site 227 is next to the second region 15₂ of the sensing region 15.

The liquid sample 71 and the solution 231 may be provided separately, that is, may be disposed in the well 220 without prior mixing of the liquid sample 71 and the solution 231. The liquid sample 71 and the solution 231 may be mixed prior to disposal in the well 220.

Referring to FIG. 23, the liquid sample 71 and the solution 231 are disposed in the well 220. The first analyte binding partner 24 can bind to the analyte 23 and the analyte 23 can bind to the immobilised second analyte binding partner 27 at the analyte binding site 226. The first analyte binding partner 24 can bind to the immobilised common binding partner 82 at the reference binding site 227. Source light 28 can be scattered at the analyte binding site 226 and light scattered at the analyte binding site 226 can be filtered and subsequently be detected by first detector 9 as described hereinbefore. Source light 97 can be scattered at the reference binding site 227 and light scattered at the reference binding site 227 can be filtered and subsequently be detected by second detector 94 as described hereinbefore. The device 230 for performing Raman spectroscopy may be included in apparatus 210.

The analyte binding site 226 and the reference binding site 227 may overlap fully or partially and reporter molecules having spectrally separated Stokes components may be used.

The well need not be cylindrical in shape. For example, a well may have a square or a rectangular base area. The well may be a microfluidic channel. A device for performing Raman spectroscopy may comprise a well having only an analyte binding site, and a corresponding sensor device. A device for performing Raman spectroscopy may comprise a well having a plurality of analyte binding sites and/or reference binding sites and a corresponding sensor device.

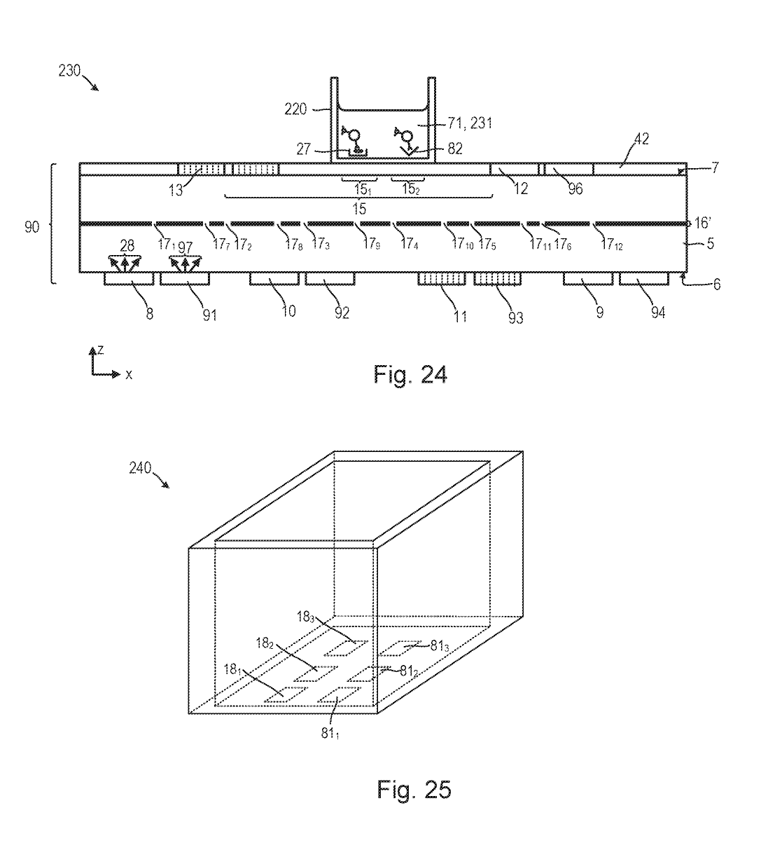

For example, referring to FIG. 24, a well 240 includes first, second, and third analyte binding sites 18₁, 18₂, 18₃ respectively and first, second, and third reference binding sites 81₁, 81₂, 81₃ respectively disposed on its inner base area 241. The well 240 may be coupled to fifth sensor device 190 (FIG. 15). Detectors 9, 192, 194 (FIG. 15) may detect light scattered at first, second, and third analyte binding sites 18₁, 18₂, 18₃ respectively. Detectors 94, 193, 195 (FIG. 15) may detect light scattered at first, second, and third reference binding sites 81₁, 81₂, 81₃ respectively.

A device for performing Raman spectroscopy may be included in a biological testing kit.

1. A device for performing Raman spectroscopy, the device comprising:
a sensor device comprising:
a transparent substrate having first and second opposite faces;
a light source, a first grating, a first reflective element, and a light detector carried by the first face of the substrate, the light source arranged to emit light towards the second face of the substrate, the light detector directed at the second face of the substrate, the first grating interposed between the light source and the light detector, the first reflective element interposed between the light source and the first grating;
a second grating and a second reflective element carried by the second face of the substrate, the second grating arranged to receive light from the light source and the second reflective element arranged to receive light from the first grating; and
a light-filtering layer disposed in the substrate between the first and second faces;
a fluidic device coupled to the sensor device next to the second face of the sensor device, the fluidic device comprising:
an analyte binding site next to the second face of the substrate;
a port and a channel between the port and the analyte binding site for directing a test sample from the port to the analyte binding site; and
wherein the light filtering layer comprises a first pair of light blocking regions arranged to provide a first aperture in a first optical path between the first grating and the detector and a second pair of light blocking regions arranged to provide a second aperture in a second optical path between the second grating and the analyte binding site.

2. A device according to claim 1, wherein the fluidic device comprises a field-enhancing particle disposed at or between the port and the analyte binding site, the field-enhancing particle suitable for binding to an analyte.

3. A device according to claim 1, wherein the fluidic device comprises a reporter disposed at or between the port and the binding site.

4. A device according to claim 1, wherein the fluidic device further comprises a reference binding site next to the second face of the substrate, wherein the analyte binding site is between the port and the reference binding site.

5. A device according to claim 1, wherein the light source and the first grating are spaced apart in a first direction, wherein the fluidic device further comprises a reference binding site next to the second face of the substrate and spaced apart from the analyte binding site in the first direction, wherein the light detector comprises a first light detector and a second light detector spaced apart in the first direction,
and wherein the light filtering layer further comprises:
a third pair of light blocking regions arranged to provide a third aperture in a third optical path between the first grating and the second light detector and a fourth pair of light blocking regions arranged to provide a fourth aperture in a fourth optical path between the second grating and the reference binding site.

6. A device according to claim 1, wherein the light source and the first grating are spaced apart in a first direction, wherein the light detector comprises a first light detector and a second light detector spaced apart in a second direction which is in the plane of the substrate and which is perpendicular to the first direction, and wherein the fluidic device further comprises a reference binding site next to the second face of the substrate, the reference binding site being spaced apart from the analyte binding site in a direction parallel to the second direction.

7. A device according to claim 1, wherein the light source and the first grating are spaced apart in a first direction, wherein the light detector comprises a first light detector and a second light detector spaced apart in a second direction which is in the plane of the substrate and which is perpendicular to the first direction, and wherein the analyte binding site is a first analyte binding site and the fluidic device further comprises a second analyte binding site next to the second face of the substrate, the second analyte binding site being spaced apart from the first analyte binding site in a direction parallel to the second direction.

8. A device according to claim 1, wherein the field-enhancing structure comprises a nanoparticle.

9. A device according to claim 1, wherein the or each analyte binding site comprises a binding partner capable of specifically binding an analyte.

10. A device according to claim 1, wherein the or each grating comprises a conductive material.

11. A device according to claim 1, wherein the or each grating comprises a dielectric material.

12. A device according to claim 1, wherein the light source comprises a layer structure which includes a light-emitting layer.

13. A device according to claim 1, wherein the sensor device and the fluidic device are spaced apart by an index-matching layer.

14. A device according to claim 1, wherein the sensor device and the fluidic device are spaced apart by an air gap.

15. A device according to claim 1, wherein the analyte provides the reporter.

16. A device according to claim 1, wherein the reporter is attached to the field-enhancing structure.

17. A device according to claim 1, wherein the fluidic device is a lateral flow device.

18. A device according to claim 1, wherein the fluidic device is a flow cell or a well.

19. A method comprising:
applying a sample to the port of a device according to claim 1.

20. Apparatus comprising:
a device according to claim 1;
a controller configured to apply a signal to the or each light source and to receive a signal from the or each detector.
